(19) United States
(12) Patent Application Publication
(10) Pub. No.: US 2025/0386821 A1
(43) Pub. Date: Dec. 25, 2025

(54) POWDER-BASED PEST CONTROL COMPOSITIONS

(71) Applicant: S. C. JOHNSON & SON, INC., Racine, WI (US)

(72) Inventors: Samuel Paul TENUTA, Racine, WI (US); Heather J. Swanson, Racine, WI (US); Meghan Pereira, Racine, WI (US)

(21) Appl. No.: 19/248,009

(22) Filed: Jun. 24, 2025

Related U.S. Application Data
(60) Provisional application No. 63/663,506, filed on Jun. 24, 2024.

(51) Int. Cl. A01N 25/12; A01N 37/02; A01N 55/02; A01N 59/00; A01N 65/22; A01N 65/44; A01P 17/00

(52) U.S. Cl. CPC A01N 25/12; A01N 37/02; A01N 55/02; A01N 59/00; A01N 65/22; A01N 65/44; A01P 17/00

(57) ABSTRACT

A pest control composition and methods of using the same are disclosed herein. The composition may comprise a foaming agent, an anti-caking agent, a surfactant, and at least one essential oil. In some embodiments a powder-based composition and methods are provided for treating drains. The pest control composition may be applied in a drain and activated with water to cause the pest control composition to react and generate a foam in the drain. The foam may then remain in the drain and/or in contact with the pests and later be washed down the drain.

### CROSS REFERENCE TO RELATED APPLICATIONS

This application claims the benefit of priority from U.S. Application No. 63/663,506, filed Jun. 24, 2024, the contents of which are incorporated herein by reference in their entirety.

### REFERENCE REGARDING FEDERALLY SPONSORED RESEARCH OR DEVELOPMENT

Not applicable.

### SEQUENCE LISTING

Not applicable.

### BACKGROUND

### 1. Technology Field

The present disclosure relates to a pest control composition and, more particularly, to a powder-based drain composition, that includes a surfactant, a foaming agent, an anti-caking agent, and at least one essential oil.

### 2. Description of the Background

Pest control compositions, including drain-fly control compositions, have been used over the years to prevent or reduce flies from coming into contact with human food or human surroundings. Specifically, drain flies, fruit flies, and sewer flies, have been identified as common nuisance pests by consumers. Traditional liquid- or gel-based pest control products are unsatisfactory because the pest control composition contained in these products only reaches the portion of the drain pipe which is in contact with the fluid carrying the composition, resulting in limited and undesirable coverage, especially in drains with irregular sink geometries. As a result, vertical and horizontal portions of the pipe receive unequal amounts of cleaning with insufficient contact time between the pest control composition and the pests. Thus, the drains must be treated more frequently with these traditional liquid- or gel-based products to maintain adequate water flow through the pipe.

Therefore, there remains a need for pest control compositions that achieve more thorough coverage of the drain pipes and longer contact time with the pests with higher efficacy in pest control.

### SUMMARY

One aspect of the present invention provides a pest control composition in the form of a powder. In certain embodiments, the composition comprises from about 0.01 wt. % to about 5 wt. % of an essential oil; from about 60 wt. % to about 99 wt. % of a foaming agent; an anti-caking agent; and a surfactant. All weight percentages are percent by weight of the total composition.

In another aspect, the present invention provides a powdered pest control composition comprising an essential oil comprising mint oil, lemongrass oil, Geranium oil, cinnamon oil, cedarwood oil, rosemary oil, clove bud oil, or any combinations thereof; a foaming agent comprising an alkali carbonate and an acid; an anti-caking agent; and a surfactant.

In another aspect, the present invention provides a method of treating pests in a drain pipe system. The method comprises introducing to the drain pipe system a powder pest control composition comprising at least one essential oil, a foaming agent, an anti-caking agent, and a surfactant; activating the pest control composition by adding an amount of water to the drain pipe system effective to cause the pest control composition to react and generate a foam before or after the introduction of the pest control composition; whereby the foam generated expands within the drain pipe system and comes in contact with the pests in the drain; and allowing the foam to remain in contact with the pests in the drain for a sufficient time.

In another aspect, the present invention provides a powdered pest control composition comprising an essential oil, a foaming agent, an anti-caking agent, and a surfactant. The composition generates a foam upon addition of a sufficient amount of water. In certain embodiments, the foam has a total volume of at least 1,000 mL³; the foam expands for a total distance or achieves a total height of at least 1 meter, in a pipe with a diameter of between about 1.0 and about 5.0 inches; the foam achieves a total cling time to a non-horizontal pipe wall of at least 40 seconds; or any combination thereof.

### BRIEF DESCRIPTION OF THE FIGURES

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows a diagram of the test apparatus in Study 1, Example 2.

FIG. 2 shows untreated drain fly larvae clinging to cotton rope near the waterline of a p-trap.

FIG. 3 shows drain fly larvae engulfed in foam above the normal waterline of a p-trap.

FIG. 4 shows the tested formulation's foaming action of emerging out of the drain up into the sink.

FIG. 5 shows the top view of a larvae lifted out of the drain into the sink bowl by the tested formulation's foaming action.

FIG. 6 shows a diagram of the test apparatus in Study 2, Example 2.

FIG. 7 shows a diagram of the test apparatus in Study 3, Example 2.

FIG. 8 shows larvae clinging to the rope near the waterline inside the p-trap before treatment.

FIG. 9 shows drain fly larvae engulfed in foam above the normal waterline of a p-trap.

FIG. 10 shows the tested formulation's foaming action of emerging out of the drain up into the sink.

FIG. 11 shows the top view of a larvae lifted out of the drain into the sink bowl by the tested formulation's foaming action.

FIG. 12 shows a diagram of the test apparatus in Study 4, Example 2.

FIG. 13 shows a plot of the foam volume generated vs. varying weight ratios of the foaming agents.

FIG. 14 shows a plot of the height of equivalent volume in a 1.25-inch pipe vs. varying weight ratios of the foaming agents. *Actual vessel used to measure volume had a diameter of 3.8″. A more conventional pipe size is 1.25″, so this chart includes the height foam would reach if we approximated that the same volume is generated.

FIG. 15 shows a plot of the foam volume generated vs. varying amounts of the total foaming agents (by weight).

FIG. 16 shows a plot of the height of equivalent volume in a 1.25-inch pipe vs. varying amounts of the total foaming agents (by weight). *Actual vessel used to measure volume had a diameter of 3.8″. A more conventional pipe size is 1.25″, so this chart includes the height foam would reach if we approximated that the same volume is generated.

FIG. 17 shows a plot of the foam volume generated vs. varying levels of surfactant (by weight).

FIG. 18 shows a plot of the height of equivalent volume in a 1.25-inch pipe vs. varying levels of surfactant (by weight). *Actual vessel used to measure volume had a diameter of 3.8″. A more conventional pipe size is 1.25″, so this chart includes the height foam would reach if we approximated that the same volume is generated.

FIG. 19 shows a test apparatus for assessing foam cling.

FIG. 20 shows the time at which 97.8% of the total original mass added (i.e., mass of water+mass of formula powder) has run out of the pipe and into the collection vessel (“Time to 97.8% Runoff”), for different formulas tested with varying ratios of the foaming agents.

FIG. 21 shows the contact angles of sample solution droplets resting on a PVC substrate, for different formulas tested with varying levels of surfactant (by weight).

FIG. 22 shows a test apparatus for assessing the % volume of CO₂ generated in the test apparatus.

FIG. 23 shows the % volume of CO₂ generated in the test apparatus (pipe) over time for formulas with varying ratios of sodium bicarbonate:citric acid (by weight).

FIG. 24 shows the % volume of CO₂ generated in the test apparatus (pipe) over time for formulas with varying levels of total foaming agents (by weight).

FIG. 25 shows the % volume of CO₂ generated in the test apparatus (pipe) at 5 min for formulas with varying ratios of sodium bicarbonate:citric acid (by weight).

FIG. 26 shows the % volume of CO₂ generated in the test apparatus (pipe) at 5 min for formulas with varying levels of total foaming agents (by weight).

FIG. 27 shows the % volume of CO₂ generated in the test apparatus (pipe) at 15 min for formulas with varying ratios of sodium bicarbonate:citric acid (by weight).

FIG. 28 shows the % volume of CO₂ generated in the test apparatus (pipe) at 15 min for formulas with varying levels of total foaming agents (by weight).

FIG. 29 shows the % volume of CO₂ generated in the test apparatus (pipe) at 30 min for formulas with varying ratios of sodium bicarbonate:citric acid (by weight).

FIG. 30 shows the % volume of CO₂ generated in the test apparatus (pipe) at 30 min for formulas with varying levels of total foaming agents (by weight).

FIG. 31 shows the % volume of CO₂ generated in the test apparatus (pipe) at 60 min for formulas with varying ratios of sodium bicarbonate:citric acid (by weight).

FIG. 32 shows the % volume of CO₂ generated in the test apparatus (pipe) at 60 min for formulas with varying levels of total foaming agents (by weight).

FIG. 33 shows the maximum bubble diameter averaged across 10 largest bubbles, for formulas with varying ratios of sodium bicarbonate:citric acid (by weight).

FIG. 34 shows the maximum bubble diameter averaged across 10 largest bubbles, for formulas with varying levels of sodium lauryl sulfate (by weight).

FIG. 35 shows the absolute maximum bubble diameter of the single largest bubble observed, for formulas with varying ratios of sodium bicarbonate:citric acid (by weight).

FIG. 36 shows the absolute maximum bubble diameter of the single largest bubble observed, for formulas with varying levels of sodium lauryl sulfate (by weight).

### DETAILED DESCRIPTION

The term “about” or “approx.”, as used herein, refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. In one embodiment, the term “about” refers to a range of values +/−5% of a specified value.

The term “weight percent”, “wt. %”, “wt. %”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

As used herein, “pests” can mean any organism whose existence it can be desirable to control. Pests can include, for example, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only to insects, but may also to mites, spiders, and other arachnids, larvae, and like invertebrates. As used herein, the term “insect” refers to and includes but is not limited to insects or arachnids capable of acting as vectors for disease to humans, animals, birds, fish, plants or plant parts, or capable of irritating or causing economic damage thereto. Examples include but are not limited to fruit flies, drain flies, sewer flies, nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites). As used herein, the term “insect” also refers to the larvae of the insects. Larva stages typically last between 8-24 days for fruit flies, drain flies, and sewer flies.

Embodiments of the invention can be used to control parasites. The term “parasite” encompasses numerous protozoa, helminths, and ectoparasites. Protozoa may include the ameba, flagellates, ciliates, and the sporozoa. Protozoa typically infect the blood and tissue and may be transmitted through the bite of a mosquito. Protozoa are responsible for such diseases as malaria, trypanosomiasis, leishmaniasis, toxoplasmosis, and cryptosporidiosis. Helminths are typically classified into three groups, flatworms, roundworms, and thorny-headed worms. Helminths are responsible for such diseases as enterobiasis, ascariasis, taeniasis, cysticercosis, and schistosomiasis. Ectoparasites may include mosquitoes, ticks, fleas, lice, and mites. Many ectoparasites may cause disease on their own, but are even more important as vectors of a number of different pathogens, including protozoa.

Further, for purposes of this application, the term “pest control” shall refer to having a repellent effect, a pesticidal effect, or both. “Repellent effect” is an effect wherein more insects are repelled away from a host or area that has been treated with the composition than a control host or area that has not been treated with the composition. Similarly, the term “repelling” or “repel” refers to the ability of the compositions described herein to cause a pest or insect to deviate away from or avoid a surface, object or insect breeding site treated with said composition. In some embodiments, as will be shown in the present disclosure, a repellent effect is an effect wherein at least about 75% of insects are repelled away from a host or area that has been treated with the composition. In some embodiments, however, a repellent effect is an effect wherein at least about 90% of insects are repelled away from a host or area that has been treated with the composition. In addition, “pesticidal effect” or “insecticidal effect” is an effect wherein treatment with a composition causes at least about 1% of the insects to die. In this regard, an LC1 to LC100 (lethal concentration) or an LD1 to LD100 (lethal dose) of a composition will cause a pesticidal or insecticidal effect. In some embodiments, the pesticidal effect or the insecticidal effect is an effect wherein treatment with a composition causes at least about 5% of the exposed insects to die. In some embodiments, the target pest is a non-insect, such as a parasite.

As used herein, the term “knocking down” or “knockdown” refers to the ability of the composition described herein to render an insect immobile. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease or irritate is severely curtailed during the period in which it is knocked down.

As used herein, the term “killing” or “kill” refers to the ability of at least one active ingredient in a composition to render an insect dead. As further used herein, the term “knocking down” or “knockdown” refers to the ability of the composition described herein to render an insect immobile for a pre-determined period of time. For example, a flying insect contacted with a composition described herein is said to be “knocked-down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down.

One aspect of the present invention provides a powder pest control composition. The composition comprises:
from about 0.01 wt. % to about 5 wt. % of an essential oil;
from about 60 wt. % to about 99 wt. % of a foaming agent;
an anti-caking agent; and a surfactant.
   All weight percentages are percent by weight of the total composition.

Another aspect of the present invention provides a powder pest control composition. The composition comprises:
an essential oil comprising mint oil, lemongrass oil, Geranium oil, cinnamon oil, cedarwood oil, rosemary oil, clove bud oil, or any combinations thereof;
a foaming agent comprising an alkali carbonate and an acid;
an anti-caking agent; and a surfactant.

Another aspect of the present invention provides a powder pest control composition. The composition comprises:
an essential oil; a foaming agent; an anti-caking agent; and a surfactant;
wherein the composition generates a foam upon addition of a sufficient amount of water; and
wherein the foam has a total volume of at least 1,000 mL³; or the foam expands for a total distance or achieves a total height of at least 1 meter, in a pipe with a diameter of between about 1.0 and about 5.0 inches; or the foam achieves a total cling time to a non-horizontal pipe wall of at least 40 seconds; or any combination thereof.

With respect to controlling pests in the drain, such as fruit flies, drain flies, or sewer flies, consumers often desire a product that can achieve sufficient contact time with the pests and thorough coverage of the area being treated. In certain embodiments, such benefits can be achieved by using the pest control composition described herein. The pest control composition described herein is typically in a dry form, such as powder, which may be readily dispensed into a pipe down the drain and quickly activated due to their relatively large surface area.

The pest control composition may be activated by the addition of a sufficient amount of water to the composition disposed within the pipe. The order of addition of water and pest control composition is not critical. The composition may evolve gas which is entrapped by a surfactant, generating foam. As the foam expands in all directions and travels through the pipes, it effectively reaches all the surfaces, cracks, and/or crevices of both horizontally and vertically oriented sections of the pipe, ensuring thorough coverage of the treated area by the pest control composition. Drains with irregular sink geometries (e.g., garbage disposal baffle, bathroom sink plunger, plunger lever) may also be effectively covered by the expanding foam.

As another unexpected advantage, the foam may also achieve a stronger “cling” to the pipe walls (e.g., longer cling time to the wall) due to lower density as compared to a liquid- or gel-based composition, resulting in longer contact time between the pest control composition and the insects and/or larvae. This is especially desirable for treatment of insects that live above the waterline (e.g., fruit flies). While the liquid- or gel-based compositions fall in the water at the bottom of the drain, foam generated from the powder-based composition disclosed herein can cling to the walls and/or expand upwards from the bottom of the drain, ensuring thorough coverage of the pipe space by the composition and elongated contact time with the insects.

Furthermore, the foam may travel through grates and/or baffles on the drain, providing much more thorough coverage of all areas within the drain comparing to liquid- or gel-based compositions. The foam may even travel vertically, against gravity, by virtue of the foam expanding. In some embodiments, the foaming action may achieve additional advantages, such as by allowing for a more efficient flushing of the pest (e.g., larvae) from the treated area, such as a kitchen sink or a drain pipe. The pest may be attached to a rope, or embedded in a rearing media, which makes regular flushing with water less efficient.

The pest control composition disclosed herein can achieve thorough coverage of the space or area being treated and/or sufficient contact time with the insects being treated. In certain embodiments, the pest control composition may be effective against insects at different stages, including the larva stage. Elimination of the larvae provides an effective means to prevent the emergence of new flies after treatment.

In certain embodiments, the pest control composition disclosed herein includes an active component.

Essential Oil. In certain embodiments, the active component comprises an essential oil. Particular strains of certain essential oils may be especially well-suited for use in certain pest control formulations, for example insecticidal or insect repellent formulations. Furthermore, essential oils may offer pleasant hedonics while providing insect killing/repelling efficacies, resulting in pest control products with reduced unpleasant, harsh, and lingering chemical odors. Suitable essential oils include, but are not limited to, mint oil (e.g., spearmint oil, peppermint, cornmint oil, and mixtures thereof), lemongrass oil, Geranium oil, cinnamon oil, cedarwood oil, rosemary oil, clove bud oil, and mixtures thereof. In certain embodiments, the oil may be carried by the surfactant, and as part of the generated foam, so that the oil may be carried to achieve effective dispersal and spread of the oil within the pipes. This is particularly useful when the oil serves as an active ingredient.

The total amount of the essential oil (e.g., the total amount of essential oil in the composition) may be from about 0.05 wt. % to about 15 wt. %, from about 0.05 wt. % to about 10 wt. %, from about 0.05 wt. % to about 8 wt. %, from about 0.05 wt. % to about 5 wt. %, from about 0.1 wt. % to about 5 wt. %, from about 0.1 wt. % to about 4 wt. %, from about 0.2 wt. % to about 3 wt. %, from about 0.2 wt. % to about 2 wt. %, from about 0.2 wt. % to about 1 wt. %, from about 0.3 wt. % to about 0.9 wt. %, from about 0.3 wt. % to about 0.8 wt. %, from about 0.4 wt. % to about 0.7 wt. %, or from about 0.4 wt. % to about 0.6 wt. %. In certain embodiments, the total amount of the essential oil may be about 0.5 wt. %.

In certain embodiments, the pest control composition described herein comprises mint oil (e.g., spearmint oil, peppermint oil, and cornmint oil). In certain embodiments, the pest control composition includes a total amount of from about 0.01 wt. % to about 5 wt. % of mint oil. In certain embodiments, the pest control composition includes a total amount of from about 0.05 wt. % to about 4 wt. % of mint oil. In certain embodiments, the pest control composition includes a total amount of from about 0.1 wt. % to about 3 wt. % of mint oil. In certain embodiments, the pest control composition includes a total amount of from about 0.2 wt. % to about 2 wt. % of mint oil. In certain embodiments, the pest control composition includes a total amount of from about 0.4 wt. % to about 1 wt. % of mint oil. In certain embodiments, the pest control composition includes a total amount of from about 0.5 wt. % of mint oil.

In certain embodiments, the pest control composition described herein comprises lemongrass oil. In certain embodiments, the pest control composition includes a total amount of from about 0.01 wt. % to about 5 wt. % of lemongrass oil. In certain embodiments, the pest control composition includes a total amount of from about 0.05 wt. % to about 4 wt. % of lemongrass oil. In certain embodiments, the pest control composition includes a total amount of from about 0.1 wt. % to about 3 wt. % of lemongrass oil. In certain embodiments, the pest control composition includes a total amount of from about 0.2 wt. % to about 2 wt. % of lemongrass oil. In certain embodiments, the pest control composition includes a total amount of from about 0.4 wt. % to about 1 wt. % of lemongrass oil. In certain embodiments, the pest control composition includes a total amount of from about 0.5 wt. % of lemongrass oil.

Spearmint oil. For the purposes of this disclosure, as used herein, “spearmint oil” may refer to both extracted and synthetic versions of Mentha spicata, Mentha crispa, Mentha crispate, Mentha cardiaca G. (scotch spearmint), Mentha spicata L. var. crispa (Bentham) Danert (native spearmint), and/or Mentha viridis, and derivatives thereof. Spearmint is also known as garden mint, common mint, lamb mint, and mackerel mint. Spearmint may also be a species of mint and may be native to Europe and southern temperate Asia, extending from Ireland in the west to southern China in the east. Further, spearmint oil includes a CAS registry number of 8008-79-5. In addition, spearmint oil may have at least one of the following constituents: carvone, d-limonene, (Z)-Dihydrocarvone, menthone, β-myrcene, α-pinene, camphene, sabinene, β-pinene, myrcene, 3-octanol, p-cymene, 1,8-cineole, (Z)-β-ocimene, cis-sabinene hydrate, linalool, cis-p-menth-2-en-1-ol, cis-limonene oxide, trans-limonene oxide, borneol, δ-terpineol, 4-terpineol, α-terpineol, dihydrocarveol, cis-dihydrocarvone, trans-carveol, cis-carveol, pulegone, isobornyl acetate, iso-dihydrocarveol acetate, β-bourbonene, β-elemene, β-caryophyllene, germacrene D, germacrene A, spathulenol, caryophyllene oxide, monoterpene hydrocarbons, oxygenated monoterpenes, sesquiterpene hydrocarbons, and/or oxygenated sesquiterpenes. In particular embodiments, the spearmint oil may have at least the following constituents: carvone, limonene, (Z)-Dihydrocarvone, 3-octanol, menthone, 1,8-cineole, and β-myrcene. Synergistic effects may be achieved when certain components in the pest control composition disclosed here are combined, and in further embodiments, when combined at particular ratios.

Peppermint oil. For the purposes of this disclosure, as used herein, “peppermint oil” may refer to both extracted and synthetic versions of Mentha balsamea Wild, Mentha x piperita L., and derivatives thereof. Peppermint can also be a hybrid mint—a cross between watermint and spearmint. Further, peppermint oil has the CAS registry number 8006-90-4, and may have at least one of the following constituents: menthol, menthone, menthyl acetate, 1,8-cineol, menthofuranne, neomenthol, isomenthone, beta-caryophyllene, germacrene D, limonene, β-pinene, terpinene-4-ol, α-pinene, (6R)-(+)-Menthofuran tr, terpinen-4-ol, (1R)-(+)-β-pulegone, germacrene, β-caryophyllene, (E)-sabinene hydrate, piperitone, and/or isomenthol. In particular embodiments, peppermint oil includes at least the following constituents: menthol, menthone, menthyl acetate, neomenthol, 1,8-cineole, (6R)-(+)-Menthofuran, isomenthone, terpinen-4-ol, (1R)-(+)-p-Pulegone, limonene, germacrene D, β-caryophyllene, (E)-Sabinene hydrate, β-pinene, piperitone, and isomenthol.

Cornmint oil. As used herein, “cornmint oil” may refer to both extracted and synthetic versions of Mentha arvensis, Mentha arvensis L., Mentha arvensis f. piperascens Malinv. Ex Holmes, Mentha arvensis L. var. galbrata Benth, Mentha arvensis L. var. villosa Benth, Mentha canadensis L., and derivatives thereof. Further, cornmint oil has a CAS registry number 68917-18-0. Cornmint is also known as field mint or wild mint. Further, like spearmint oil and peppermint oil, cornmint oil is a species of flowering plant in the mint family Lamiaceae. Cornmint oil may also have at least one of the following constituents: cis-beta-ocimene, β-phellandrene, gamma-terpinene, terpinolene, α-pinene, neomenthol, santene, α-thujene, p-cymene, β-farnesene, β-caryophyllene, betabourbonene, myrcene, β-myrcene, α-terpinene, delta-terpinene, limonene, β-pinene, camphene, sabinene, germacrene D, gamma-caryophyllene, delta-cardinene, ethanol, 3-methylbutanol, 3-octanol, citronellolnerol, menthol, isomenthol, α-terpineol, isopulegol, cis-carveol, pmenthan-2,5-diol, isocaryophyllenol, butanol, (Z)-3-hexenol, 2,6-nonadienol, geraniol, neoisomenthol, terpinen-4-ol, neoiso(iso)pulegol, trans-carveol, borneol, viridiflorol, acetaldehyde, 3-methylbutanal, geranial, 2-methylpropanal, 2,6-nonadienal, neral, acetone, 2-heptanone, 2-isopropylcyclopentanone, 3-methylcyclohexanone, menthone, piperitone, carvone, 2-butanone, methylheptenone, cis-jasmone, carvomenthone, isomenthone, pulegone, (1R)-(+)-p-pulegone, iso-isopulegol, formic acid, 3-methylbutanoic acid, hexanoic acid, nonanoic acid, acetic acid, pentanoic acid, (E)-2-hexenyl acetate, (Z)-3-hexenyl acetate, l-octen-3-yl acetate, geranyl acetate, linalyl acetate, menthyl acetate, isomenthyl acetate, neomenthyl acetate, neoisomenthyl acetate, dihydrocarvyl acetate, (Z)-3-hexenyl 3-methylbutanoate, menthyl 3-methylbutanoate, menthyl pentanoate, (Z)-3-hexenyl hexanoate, menthyl hexanoate, (Z)-3-hexenyl 2-hydroxybenzoate, (E)-2-hexenyl phenylacetate, (Z)-3-hexenyl phenylacetate, 3-phenylpyridine, 3-phenyl-4-propylpyridine, menthofuran, menthofurolactone, 1,8-cineole, trans-2,5-diethylfuran, 3-(5,5-dimethyltetrahydro-2-furyl)-(Z)-2-butenol-1, piperitone oxide, beta-caryophyllene oxide, and/or 2-isopropyl-5-methylphenol (thymol). In particular embodiments, cornmint oil may include the following major constituents: menthol and menthone.

Geranium oil. As used herein, “Geranium oil” refers to both extracted and synthetic oils of Geranium, and derivatives thereof. Geranium is a genus of 422 species of annual, biennial, and perennial plants that are commonly known as geraniums or cranesbills. Geranium oil has the CAS registry number 8000-46-2 and at least one of the following constituents: citronellol, geraniol, linalool, citronellyl formiate, menthone, geranyl-formiate, 3,7-gvaiedien, alpha-terpineol, izomenthon, beta-burbonen, tetrahydrogeraniol, alpha-pinene, geranyl-butyrate, linalyl-propionate, cis-rozokside, geranyl-tiglate, beta-caryophyllene, citronellyl-propionate, citronellyl-butyrate, calamenen, neryl-propionate, benzylidene camphor, geranyl-propionate, and/or delta-gvaien. In particular embodiments, Geranium oil may include the following major constituents: Citronellol, Citronellyl formate, Geraniol, Guaia-6,9-diene, Isomenthone, Linalool, Menthone, Geranyl formate, (Z)- +(E)-Rose oxide, Germacrene, Geranyl tiglate, Citronellyl propionate, (3-Caryophyllene, Citronellyl tiglate, Geranyl butyrate, β-Bourbonene.

Cinnamon oil. As used herein, “cinnamon oil” refers to both extracted and synthetic oils of species from the genus Cinnamomum in the family Lauraceae, and derivatives thereof. Cinnamon oil has the CAS registry number 8015-91-6 and can have at least one of the following constituents: benzenepropanal, borneol, 3-phenyl-2-propenal, trans-cinnamaldehyde, (+)-cyclosativene, alpha-cubebene, (+)-sativene, 1-caryophyllene, gamma-muurolene, gamma-maaliene, alpha-muurolene, 1,2,4a,5,6,8a-hexahydro-4,7-dimethyl-1-(1-methylethyl)naphthalene, d-cadinene, 1,6-dimethyl-4-(1-methyletyhl)-(1,2,3,4,4a,7)hexahydronaphthalene, 1,1,6-trimethyl-1,2-dihydronaphthalene, t-muurolol, and/or alpha-copaene. In particular embodiments, cinnamon oil may include the following major constituents: Eugenol, Eugenyl acetate, Linalool, (E)-Cinnamyl acetate, Benzyl benzoate, β-Caryophyllene, (E)-Cinnamaldehyde, Safrole, Cinnamyl alcohol.

Cedarwood oil. As used herein, “cedarwood oil” refers to both extracted and synthetic oils produced from distilling wood of a number of different junipers and cypresses (of the family Cupressaceae), and derivatives thereof. Cedarwood oil includes the following CAS registry numbers 85085-29-6,68990-83-0, or 8000-27-9, and may include at least one of the following constituents: α-pinene, α-thujene, Camphene, β-pinene, Sabinene, Myrcene, α-terpinene, Limonene, β-phellandrene, γ-terpinene, p-cymene, Terpinolene, Isolongifolene, β-cubebene, Linalool, α-longipinene, α-cedrene, α-barbatene, β-cedrene, Terpinen-4-ol, β-funebrene, cis-p-menth-2-en-1-ol, Thujopsene (widdrene), allo-aromadendrene, β-barbatene, trans-piperitol, Selina-4,11-diene, β-chamigrene, α-terpineol, Pseudowiddrene, Bicyclogermacrene, α-cuprenene, Thujopsadiene, δ-cadinene, ar-curcumene, β-cuprenene, Cuparene, Dehydro-β-ionone, 8,9-dehydroneolongifolene, α-cedrol, Widdrol, 3-thujopsanone, α-cadinol, α-cedrenal, α-bisabolol, and/or Thujopsenal, Mayurone. In particular embodiments, cedarwood oil may include the following major constituents: Iso-α-cedrene, Thujopsene, Cedrenol, Cuparene, Longifolene, α-Cedrene, β-Cedrene, Cedrol, Widdrol, α-Chamigrene, β-Chamigrene, α-Selinene, β-Himachalene.

Rosemary oil. As used herein, “rosemary oil” refers to both extracted and synthetic versions of oils from Rosmarinus officinalis, Limonium vulgare, Andromeda polifolia, and derivatives thereof. Further, rosemary oil includes a CAS registry number of 8000-25-7, and may include at least one of the following constituents: tricyclene, alpha-thujene, alpha-pinene, camphene, sabinene, beta-pinene, myrcene, alpha-phellandrene, car-3-ene, alpha-terpinolene, p-cymene, 1,8-cineole, limonene, gamma-terpinene, trans-sabinene, terpinolene, linalool, alpha-campholenol, endo-fenchol, and/or camphor. In particular embodiments, rosemary oil may include the following major constituents: 1,8-cineole, borneol, camphor, verbenone, α-pinene, bornyl acetate, linalool, camphene, β-caryophyllene, α-terpineol, p-cymene, ar-curcumene, 1-nonanol, and terpinen-4-ol.

Particular strains of certain essential oils may be especially well-suited for use in certain oil-based insect repellent formulations. For the purposes of this disclosure, “peppermint oil” is defined to be the oil of Mentha arvenis, the oil of Mentha piperita, and any combination thereof. For example, in certain formulations, it is particularly advantageous to use the Arvensis strain of peppermint oil (i.e. Mentha arvenis). The oil of Mentha arvenis is sometimes commonly referred to as cornmint oil. Without wishing to be bound by any particular theory, Mentha arvenis oil may be particularly advantageous due to the unusually high levels of menthol that it contains. One skilled in the art will appreciate that Mentha arvenis oil may be difficult to use in certain liquid formulations, as its menthol levels are so high that when distilled the oil is usually solid. One skilled in the art will also recognize that it may be particularly advantageous to configure any and/or all of the embodiments disclosed herein such that some or all of the peppermint oil in a given embodiment is Mentha arvenis oil. Additionally, in certain formulations, it may be particularly advantageous to use the Piperita strain of peppermint oil (i.e. Mentha piperita). One skilled in the art will appreciate that Mentha piperita oil may be difficult to use in certain liquid formulations, for reasons similar to those discussed above with respect to Mentha arvenis oil. However, one skilled in the art will also recognize that it may be particularly advantageous to configure any and/or all of the embodiments disclosed herein such that some or all of the peppermint oil in a given embodiment is Mentha piperita oil. As another example, in certain formulations, it may be advantageous to use a particular type of clove oil, such as clove bud oil, clove leaf oil, or clove stem oil. Without wishing to be bound by any particular theory, different types of clove oil may commonly contain different concentrations of eugenol, which may affect the repellency/efficacy of the particular type of clove oil. Typically, clove bud oil has 60-90 wt % eugenol, clove leaf oil has 70-82 wt % eugenol, and clove stem oil has 85-92 wt % eugenol. One skilled in the art will also recognize that it may be particularly advantageous to configure any and/or all of the embodiments disclosed herein such that some or all of the clove oil in a given embodiment is any one of clove oil, such as clove bud oil, clove leaf oil, clove stem oil, or a combination thereof. As still another example, in certain formulations, it may advantageous to use a particular strain of Geranium oil, such as the Egyptian strain of Geranium oil or the Bourbon strain of Geranium oil. One skilled in the art will also recognize that it may be particularly advantageous to configure any and/or all of the embodiments disclosed herein such that some or all of the Geranium oil in a given embodiment is any one of the Egyptian strains of Geranium oil, the Bourbon strain of Geranium oil, or a combination thereof.

Other plant-based natural oil or natural oil extract that may be contained in the embodiments of the pest control compositions described herein may comprise neem oil, karanja oil, clove oil, thyme oil, oregano oil, garlic oil, anise oil, lime oil, lavender oil, thymol (found in oregano oil and thyme oil), p-cymene (found in oregano oil and thyme oil), 1,8-cineole (found in thyme oil and peppermint oil), eugenol (found in clove oil and cinnamon oil), limonene (found in cinnamon, peppermint, and lime oil), alpha-pinene (found in cinnamon oil, Geranium oil, and lime oil), carvacrol (found in oregano oil, thyme oil, and clove oil), gamma-terpinene (found in oregano oil and lime oil), geraniol (found in thyme oil and Geranium oil), alpha-Terpineol (found in thyme oil and anise oil), beta-caryophyllene (found in clove oil, cinnamon oil, and peppermint oil) and linalool (found in thyme oil, cinnamon oil and Geranium oil, amongst others), or mixtures thereof. In other embodiments, the pest control natural oil may comprise any oil having as a constituent one of the following compounds, or a combination of the following compounds: azadirachtin, nimbin, nimbinin, salannin, gedunin, geraniol, geranial, gamma-terpinene, alpha-terpin-eol, beta-caryophyllene, terpinen-4-ol, myrcenol-8, thuya-nol-4, benzyl alcohol, cinnamaldehyde, cinnamyl acetate, alpha-pinene, geranyl acetate, citronellol, citronellyl formate, isomenthone, 10-epi-gamma-eudesmol, 1,5-dimethyl-1-vinyl-4-hexenylbutyrate, 1,3,7-octatriene, eucalyptol, camphor, diallyl disulfide, methyl allyl trisulfide, 3-vinyl-4H-1,2 dithiin, 3-vinyl-1,2 dithiole-5-cyclohexane, diallyl trisulfide, anethole, methyl chavicol, anisaldehyde, estragole, linalyl acetate, geranial, beta-pinene, thymol, carvacrol, p-cymene, beta-myrcene, alpha-myrcene, 1,8-cin-eole, eugenol, limonene, alpha-pinene, menthol, menthone, linalool, or mixtures thereof.

In further embodiments, other plant-based natural oil or natural oil extract that may be contained in the embodiments of the pest control compositions described herein may comprise alpha- or beta-pinene; alpha-camp-holenic aldehyde; alpha-citronellol; alpha-iso-amyl-cinnamic (e.g., amyl cinnamic aldehyde); alpha-pinene oxide; alpha-cinnamic terpinene; alpha-terpineol (e.g., 1-methyl-4-isopropyl-1-cyclohexen-8-ol); lamda-terpinene; achillea; aldehyde C16 (pure); allicin; alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borneol; Calamus; camphor; Cananga oil (e.g., java); cardamom; carnation (e.g., Dianthus caryophyllus); carvacrol; carveol; Cassia; Castor; cedar (e.g., hinoki); chamomile; cineole; cinnamaldehyde; cinnamic alcohol; cis-pinane; citral (e.g., 3,7-dimethyl-2,6-octadienal); Citronella; citronellal; citronellol dextro (e.g., 3-7-dimethyl-6-octen-1-ol); citronellol; citronellyl acetate; citronellyl nitrile; Citrus unshiu; clary sage; clove (e.g., eugenia caryophyllus); clove bud; coriander; corn; cotton seed; d-dihydrocarvone; decyl aldehyde; diallyl disulfide; diethyl phthalate; dihydroanethole; dihydrocarveol; dihy drolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); Eucalyptus citriodora; Eucalyptus globulus; Eucalyptus; eugenol (e.g., 2-methoxy-4-allyl phenol); evening primrose; fenchol; fennel; Femiol™; fish; florazon (e.g., 4-ethyl-.alpha., .alpha.-dimethyl-benzenepropanal); galaxolide; geraniol (e.g., 2-trans-3,7-dimethyl-2,6-octadien-8-ol); geraniol; geranyl acetate; geranyl nitrile; ginger; grapefruit; guaiacol; guaiacwood; gurjun balsam; heliotropin; herbanate (e.g., 3-(1-methyl-ethyl) bicyclo(2,2,1) hept-5-ene-2-carboxylic acid ethyl ester); hiba; hydroxycitronellal; i-carvone; i-methylacetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalyl acetate; linseed; Litsea cubeba; I-methyl acetate; longifolene; mandarin; Mentha; menthane hydroperoxide; menthol crystals; menthol laevo (e.g., 5-methyl-2-isopropyl cyclohexanol); menthol; menthone laevo (e.g., 4-isopropyl-1-methylcyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., Myristica fragrans); orange (e.g., Citrus aurantium dulcis); orris (e.g., Iris florentina) root; para-cymene; para-hydroxy phenyl butanone crystals (e.g., 4-(4-hydroxphenyl)-2-butanone); passion palmarosa oil (e.g., Cymbopogon martini), patchouli (e.g., Pogostemon cablin), p-cymene; pennyroyal oil; pepper; peppermint (e.g., Mentha piperita), perillaldehyde; petitgrain (e.g., Citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., Rosmarinus officinalis), ryu; sage; sandalwood (e.g., Santa-lum album), sandenol; Sassafras; sesame; soybean; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (methyl salicylate) oils, or mixtures thereof.

Other suitable essential oils for use in the pest control compositions described herein include Absinth Oil, Almond Oil, Ambrette Seed Oil, Amyris Oil, Angelica Root Oil, Anethole 20/21 natural, Angelica Seed Oil, Aniseed Oil China star, Anise Star Oil, Balsam Fir Oil, Balsam Oil, Basil Oil, Bay Oil, Bergamot Oil, Birch Sweet Oil, Birch Tar Oil, Bitter Almond Oil, Bitter Orange Oil Cold Pressed, Black Pepper Oil Black Pepper Oleoresin 40/20, Bois de Rose, Buchu Oil, Cabreuva Oil, Cade Oil, Cajeput Oil, Calamus Oil, Camphor Oil White, Cananga Oil, Capsicum Oil, Caraway Seed Oil, Cardamom Seed Oil, Carrot Seed Oil, Cassia Oil, Cedar leaf Oil, Cedarwood Oil, Celery Leaf Oil, Celery Seed Oil, Chamomile Flower Oil, Chenopodium Oil (Wormseed), Cinnamon Bark Oil, Cinnamon Leaf Oil, Cistus Oil, Citronella Oil, Citronellol Terpenes, Clary Sage Oil, Clove Bud Oil, Clove Leaf Oil, Clove Stem Oil, Cognac Oil Green, Cognac Oil White, Copaiba Oil, Coriander Leaf Oil, Coriander Seed Oil, Cornmint Oil (Mentha Arvensis), Cumin Seed Oil, Cyclamen Oil, Cypress Oil, Davana Oil, Dill Herb Oil, Erigeron Oil, Estragon Oil (Tarragon Oil), Eucalyptus Oil, Fennel Oil Bitter, Fennel Oil Sweet, Fir Needle Oil, Galbanum Oil, Garlic Oil, Geranium Oil, Ginger Oil, Grapefruit Oil 10-Fold, Grapefruit Oil 5-Fold, Grapefruit Oil Cold Pressed, Grapefruit Oil Terpenes, Guaiac Wood Oil, Gurjun Balsam, Hemlock Oil (Spruce), Ho Leaf Oil, Ho Wood Oil, Hyssop Oil, Jasmin Oil, Juniper Berry Oil, Laurel Leaf Oil, Lavandin Oil, Lavender Oil, Lavender Spike Oil, Lemon Oil 10-Fold, Lemon Oil 5-Fold, Lemon Oil Cold Pressed, Lemon Oil Distilled, Lemon Oil Terpenes, Lemon Oil Washed, Lemongrass Oil, Lemongrass Oil Terpeneless, Lime Oil 5-Fold, Lime Oil Distilled, Lime Oil Terpenes, Lime Oil Washed, Litsea Cubeba Berry Oil, Mace Oil, Mandarin Oil Cold Pressed, Marjoram Oil Sweet, Musk Oil, Myrtel Oil, Neroli Oil, Nutmeg Oil, Ocotea cymbarum Oil, Onion Oil, Orange Oil Bitter Cold Pressed, Orange Oil 10-Fold, Orange Oil 20-Fold, Orange Oil 5-Fold, Orange Oil Bitter 5-Fold, Orange Oil Cold Pressed, Orange Oil Terpeneless, Oregano Oil, Origanum Oil, Palmarosa Oil, Parsley Leaf Oil, Parsley Seed Oil, Patchouli Oil, Pennroyal Oil, Pepper Oil Black, Peppermint Oil, Petitgrain Oil, Pimenta Berry Oil, Pimenta Leaf Oil, Pine Needle Oil, Pine Oil Scotch, Pine Oil White, Rosalin Oil, Rose Oil, Sage Clary Oil, Sage Oil, Sandalwood Oil, Sassafras Oil, Savory Oil, Spike Lavender Oil (Lavender Spike), Spruce Oil (Hemlock), Star Anise Oil, Styrax Oil, Tagetes Oil, Tangelo Oil, Tangerine Oil, Tangerine Oil 5-Fold, Tangerine Oil Terpenes, Tarragon Oil (Estragon Oil), Tea Tree Oil, Thyme Oil, Thyme Oil White, Tumeric Oil, Purpentine Oil, Valerian Oil, Vanilla beans abs., Vetiver Oil, Wintergreen Oil (Methyl Salicylate Natural), Wormseed Oil, Wormwood Oil, and Ylang Ylang Oil.

Surfactant. The pest control composition disclosed herein may include a surfactant. The surfactant may contribute to the generation of foam, which distributes the active component (e.g., essential oil) throughout the treated space/area. Foam expansion allows for more thorough coverage of the treated space/area and longer contact time between the active component and the insects. In certain embodiments, a film may be formed after the foam and/or bubbles recede, or when the surfactant comes into contact with the insects, which covers the spiracles of the insects and leads to mortality through suffocation, achieving synergistic effects in insect control and/or repellency.

In certain embodiments, a solution (e.g., 5% solution) of the composition disclosed herein is prepared in water. For example, a droplet (e.g., a 10 uL droplet) of the composition solution is deposited to a PVC substrate and the resulting static contact angle of the droplet on PVC is measured using the sessile drop technique taking a profile image via back illumination using a goniometer. In certain embodiments, the contact angle of the droplet of the composition water solution is less than 45 degrees, less than 40 degrees, less than 35 degrees, less than 30 degrees, less than 25 degrees, less than 20 degrees, less than 15 degrees, less than 10 degrees, or less than 5 degrees. In certain embodiments, the polarity of the film may be determined by measurements of the contact angle of a water droplet resting on a layer of the film. Film compositions with lower contact angle may coat insects/eggs/larvae more effectively. In certain embodiments, the film produces contact angles of less than 45 degrees, less than 40 degrees, less than 35 degrees, less than 30 degrees, less than 25 degrees, less than 20 degrees, less than 15 degrees, less than 10 degrees, or less than 5 degrees with a droplet of water. In certain embodiments, the film produces contact angles of less than 15 degrees with a droplet of water.

In certain embodiments, the film formed may persist for at least 30 seconds, at least 1 minute, at least 2 minutes, at least 5 minutes, at least 8 minutes, at least 10 minutes, at least 15 minutes, at least 20 minutes, at least 25 minutes, at least 30 minutes, at least 35 minutes, at least 40 minutes, at least 45 minutes, at least 50 minutes, at least 55 minutes, or at least 1 hour from the time the pest control composition is poured down the drain. In certain embodiments, the film formed may persist for at least 15 minutes from the time the pest control composition is poured down the drain.

Surfactants that may be employed in the present invention include anionic, nonionic and amphoteric, and mixtures thereof. The total amount of the surfactant (e.g., the total amount of surfactant in the composition) may be from about 0.1 wt. % to about 15 wt. %; from about 0.5 wt. % to about 10 wt. %; from about 0.5 wt. % to about 9 wt. %, from about 0.5 wt. % to about 8 wt. %, from about 0.5 wt. % to about 7 wt. %, from about 0.5 wt. % to about 6 wt. %, from about 0.5 wt. % to about 5 wt. %, from about 1 wt. % to about 4.5 wt. %, from about 1.5 wt. % to about 4.5 wt. %, or from about 1.5 wt. % to about 3.5 wt. %. In certain embodiments, the total amount of surfactant may be about 2.5 wt. %.

Suitable anionic surfactants include, but are not limited to, alpha olefin sulfonates, the alkyl aryl sulfonic acids and their alkali metal and alkaline earth metal salts such as sodium dodecyl benzene sulfonate, magnesium dodecyl benzene sulfonate, disodium dodecyl benzene disulfonate and the like as well as the alkali metal salts of fatty alcohol esters of sulfuric and sulfonic acids, the alkali salts of alkyl aryl (sulfothioic acid) ethers, alkyl thiosulfuric acid and soaps such as coco or tallow, etc. In certain embodiments, anionic surfactants include sodium dodecyl benzene sulfonate available under the tradename Nacconal 40-G from Stepan Company, Northfield, Ill.; and sodium lauryl sulfate (“SLS”) because of its detergency, wetting, foam enhancing and emulsifying properties. SLS is available in dry form under the trade designation Stepanol ME-Dry from the Stepan Chemical Company.

In certain embodiments, the pest control composition includes from less than 1 wt. % to about 15 wt. % of sodium lauryl sulfate. In certain embodiments, the pest control composition includes a total amount of from about 0.5 wt. % to about 10 wt. % of sodium lauryl sulfate. In certain embodiments, the pest control composition includes a total amount of from about 1 wt. % to about 9 wt. % of sodium lauryl sulfate. In certain embodiments, the pest control composition includes a total amount of from about 1 wt. % to about 8 wt. % of sodium lauryl sulfate. In certain embodiments, the pest control composition includes a total amount of from about 1 wt. % to about 7 wt. % of sodium lauryl sulfate. In certain embodiments, the pest control composition includes a total amount of from about 1 wt. % to about 6 wt. % of sodium lauryl sulfate. In certain embodiments, the pest control composition includes a total amount of from about 1 wt. % to about 5 wt. % of sodium lauryl sulfate. In certain embodiments, the pest control composition includes a total amount of from about 1.5 wt. % to about 4.5 wt. % of sodium lauryl sulfate. In certain embodiments, the pest control composition includes a total amount of from about 1.5 wt. % to about 4.5 wt. % of sodium lauryl sulfate. In certain embodiments, the pest control composition includes a total amount of from about 1.5 wt. % to about 3.5 wt. % of sodium lauryl sulfate. In certain embodiments, the pest control composition includes a total amount of about 2.5 wt. % of sodium lauryl sulfate.

Suitable nonionic surfactants include, but are not limited to, the ethylene oxide esters of alkyl phenols such as (nonylphenoxy) polyoxyethylene ether, the ethylene oxide ethers of fatty alcohols such as tridecyl alcohol polyoxyethylene ether, the propylene oxide ethers of fatty alcohols, the ethylene oxide ethers of alkyl mercaptans such as dodecyl mercaptan polyoxyethylene thioester, the ethylene oxide esters of acids such as the lauric ester of methoxy polyethylene glycol, the ethylene oxide ethers of fatty acid amides, the condensation products of ethylene oxide with partial fatty acid esters of sorbitol such as the lauric ester of sorbitan polyethylene glycol ether, and other similar materials.

Suitable amphoteric surfactants include, but are not limited to, the fatty imidazolines, such as 2-coco-1-hydroxyethyl-1-carboxymethyl-1-hydroxylimidazoline and similar compounds made by reacting monocarboxylic fatty acids having chain lengths of 10 to 24 carbon atoms with 2-hydroxy ethyl ethylene diamine and with monohalo monocarboxylic fatty acids.

An additional class of surfactants include, but are not limited to, amine oxides which demonstrate cationic surfactant properties in acidic pH and nonionic surfactant properties in alkaline pH. Exemplary amine oxides include dihydroxyethyl cocamine oxide, tallowamidopropylamine oxide and lauramine oxide.

The compositions of the present disclosure, and the active component thereof, may also include ingredients other than surfactants and essential oils. In certain embodiments, for example, the compositions of the present disclosure may include at least one foaming agent and/or an anti-caking agent.

Foaming agent. In certain embodiments, the pest control composition disclosed herein includes a foaming agent. The foaming agent is generally capable of generating any type of gas, such as oxygen, nitrogen, or carbon dioxide gas. The total amount of the foaming agent (e.g., the total amount of foaming agent in the composition) may be from about 50 wt. % to about 99 wt. %; from about 60 wt. % to about 99 wt. %; from about 70 wt. % to about 99 wt. %; from about 80 wt. % to about 99 wt. %; from about 85 wt. % to about 98 wt. %; from about 85 wt. % to about 97 wt. %; from about 85 wt. % to about 96 wt. %; from about 85 wt. % to about 95 wt. %; from about 85 wt. % to about 90 wt. %, or from about 90 wt. % to about 95 wt. %. In certain embodiments, the total amount of the foaming agent may be about 91 wt. %. In certain embodiments, the total amount of the foaming agent may be about 87 wt. %.

For carbon-dioxide-generating systems, the foaming agent may comprise an alkali carbonate and an acid. The alkali carbonate and acid undergo chemical reactions that generate CO₂, which may form foam and/or bubbles upon agitation and interaction with water, surfactant (e.g., sodium lauryl sulfate), and/or essential oil(s). Suitable alkali carbonates include, but are not limited to, sodium and potassium carbonates, such as sodium carbonate, sodium bicarbonate, potassium carbonate, potassium bicarbonate, and mixtures thereof. In certain embodiments, the pest control composition includes sodium bicarbonate. The total amount of the alkali carbonate (e.g., the total amount of alkali carbonate in the composition) may be from about 5 wt. % to about 90 wt. %; from about 10 wt. % to about 80 wt. %; from about 20 wt. % to about 75 wt. %; from about 30 wt. % to about 70 wt. %; from about 40 wt. % to about 65 wt. %; from about 45 wt. % to about 60 wt. %; or from about 50 wt. % to about 60 wt. % by weight. In certain embodiments, the total amount of the alkali carbonate may be about 56 wt. %. In certain embodiments, the total amount of the alkali carbonate may be about 54 wt. %.

In certain embodiments, the pest control composition includes a total amount of from about 5 wt. % to about 90 wt. % of sodium bicarbonate. In certain embodiments, the pest control composition includes a total amount of from about 10 wt. % to about 80 wt. % of sodium bicarbonate. In certain embodiments, the pest control composition includes a total amount of from about 20 wt. % to about 75 wt. % of sodium bicarbonate. In certain embodiments, the pest control composition includes a total amount of from about 30 wt. % to about 70 wt. % of sodium bicarbonate. In certain embodiments, the pest control composition includes a total amount of from about 40 wt. % to about 65 wt. % of sodium bicarbonate. In certain embodiments, the pest control composition includes a total amount of from about 45 wt. % to about 60 wt. % of sodium bicarbonate. In certain embodiments, the pest control composition includes a total amount of from about 50 wt. % to about 60 wt. % of sodium bicarbonate. In certain embodiments, the pest control composition includes a total amount of about 56 wt. % of sodium bicarbonate. In certain embodiments, the pest control composition includes a total amount of about 54 wt. % of sodium bicarbonate.

Suitable acids for use in the present invention include without limitation, citric, sodium citrate, fumaric, adipic, maleic, oxalic, lactic, sulfamic and acid-forming salts such as sodium sulfite, sodium bisulfate and potassium citrate. In certain embodiments, the pest control composition includes citric acid, such as anhydrous citric acid. The total amount of the acid (e.g., the total amount of acid in the composition) may be from about 5 wt. % to about 90 wt. %; from about 10 wt. % to about 80 wt. %; from about 15 wt. % to about 70 wt. %; from about 15 wt. % to about 60 wt. %; from about 20 wt. % to about 55 wt. %; from about 25 wt. % to about 50 wt. %; from about 30 wt. % to about 50 wt. %; from about 30 wt. % to about 40 wt. %; from about 32 wt. % to about 38 wt. %; or from about 32 wt. % to about 36 wt. % by weight. In certain embodiments, the total amount of the acid may be about 35 wt. %. In certain embodiments, the total amount of the acid may be about 33 wt. %.

In certain embodiments, the pest control composition includes a total amount of from about 5 wt. % to about 90 wt. % of citric acid. In certain embodiments, the pest control composition includes a total amount of from about 10 wt. % to about 80 wt. % of citric acid. In certain embodiments, the pest control composition includes a total amount of from about 15 wt. % to about 70 wt. % of citric acid. In certain embodiments, the pest control composition includes a total amount of from about 15 wt. % to about 60 wt. % of citric acid. In certain embodiments, the pest control composition includes a total amount of from about 20 wt. % to about 55 wt. % of citric acid. In certain embodiments, the pest control composition includes a total amount of from about 25 wt. % to about 50 wt. % of citric acid. In certain embodiments, the pest control composition includes a total amount of from about 30 wt. % to about 50 wt. % of citric acid. In certain embodiments, the pest control composition includes a total amount of from about 30 wt. % to about 40 wt. % of citric acid. In certain embodiments, the pest control composition includes a total amount of from about 32 wt. % to about 38 wt. % of citric acid. In certain embodiments, the pest control composition includes a total amount of from about 32 wt. % to about 36 wt. % of citric acid. In certain embodiments, the pest control composition includes a total amount of from about 35 wt. % of citric acid. In certain embodiments, the pest control composition includes a total amount of from about 33 wt. % of citric acid.

The ratio of the alkali carbonate and the acid in the foaming agent may vary. In certain embodiments, the alkali carbonate and the acid have a weight ratio of from about 0.5:1 to about 3:1. In certain embodiments, the alkali carbonate and the acid have a weight ratio of from about 0.8:1 to about 2.5:1. In certain embodiments, the alkali carbonate and the acid have a weight ratio of from about 1:1 to about 2.2:1. In certain embodiments, the alkali carbonate and the acid have a weight ratio of from about 1:1 to about 2:1. In certain embodiments, the alkali carbonate and the acid have a weight ratio of from about 1.2:1 to about 2:1. In certain embodiments, the alkali carbonate and the acid have a weight ratio of from about 1.3:1 to about 1.9:1. In certain embodiments, the alkali carbonate and the acid have a weight ratio of from about 1:4 to about 1.8:1. In certain embodiments, the alkali carbonate and the acid have a weight ratio of from about 1.4:1 to about 1.7:1. In certain embodiments, the alkali carbonate and the acid have a weight ratio of about 1.6:1.

In certain embodiments, the foaming agent comprises sodium bicarbonate and citric acid. In certain embodiments, the sodium bicarbonate and the citric acid have a weight ratio of from about 0.5:1 to about 3:1. In certain embodiments, the sodium bicarbonate and the citric acid have a weight ratio of from about 0.8:1 to about 2.5:1. In certain embodiments, the sodium bicarbonate and the citric acid have a weight ratio of from about 1.1:1 to about 2.2:1. In certain embodiments, the sodium bicarbonate and the citric acid have a weight ratio of from about 1.1:1 to about 2:1. In certain embodiments, the sodium bicarbonate and the citric acid have a weight ratio of from about 1.2:1 to about 2:1. In certain embodiments, the sodium bicarbonate and the citric acid have a weight ratio of from about 1.3:1 to about 1.9:1. In certain embodiments, the sodium bicarbonate and the citric acid have a weight ratio of from about 1:4 to about 1.8:1. In certain embodiments, the sodium bicarbonate and the citric acid have a weight ratio of from about 1.5:1 to about 1.7:1. In certain embodiments, the sodium bicarbonate and the citric acid have a weight ratio of about 1.6:1.

In certain embodiments, the foaming agent comprises sodium bicarbonate and citric acid and carbon dioxide (CO₂) is generated by the following reaction:

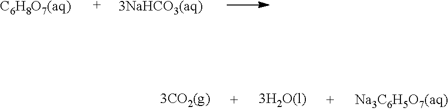

The CO₂ generated may provide another means to asphyxiate the larvae and/or insects and contribute to higher efficacy of the pest control composition, achieving a synergistic effect with the active component and the surfactant. In certain embodiments, the CO₂ generated and/or released from the foams and/or bubbles may form a layer or a “pool” of CO₂ in the pipe, due to its higher density comparing to air. Such layer or “pool” of CO₂ may provide synergistic effect in asphyxiating the larvae and/or insects. For example, in certain embodiments, the pest control composition described herein may achieve commercially acceptable level of mortality rate, such as at least 90%, at least 95%, at least 99% or 100% of mortality rate, after a short exposure period with the pests.

In certain embodiments, the pest control composition disclosed herein may generate CO₂ that occupies at least 10%, at least 20%, at least 30%, at least 40%, at least 50%, at least 60%, at least 70%, at least 80%, or at least 90% of the volume of the space within the test vessel (e.g., a drain pipe or a sink trap) at 5 min, 15 min, 30 min, or 60 min after being mixed with a sufficient amount of water for foam/gas formation, at about 0.01 to about 0.20 g/mL³, or about 0.03 to about 0.12 g/mL³ of dosage.

The foam generated by the pest control composition disclosed herein may comprise bubbles of various sizes. In certain embodiments, smaller bubble sizes may lead to more film formed by the surfactant (e.g., SLS) due to a higher surface area to volume ratio. In certain embodiments, smaller bubble sizes may also lead to a stronger “cling” (e.g., longer cling time) on the pipe walls. In certain embodiments, the foam generated can achieve a “total cling time” to a non-horizontal pipe wall (e.g., a vertical pipe wall) for at least 30 seconds, at least 40 seconds, at least 50 seconds, at least 60 seconds, at least 70 seconds, at least 80 seconds, at least 90 seconds, at least 100 seconds, at least 110 seconds, at least 2 minutes, at least 3 minutes, at least 4 minutes, at least 5 minutes, at least 8 minutes, at least 10 minutes, at least 15 minutes, at least 20 minutes, at least 25 minutes, at least 30 minutes, at least 35 minutes, at least 40 minutes, at least 45 minutes, at least 50 minutes, at least 55 minutes, or at least 1 hour, up to about 5 hours. In certain embodiments, “total cling time” is defined as the time at which about 97.8% of the total original mass (i.e., mass of water+mass of formula powder) has run out of the pipe.

In certain embodiments, the disclosed pest control composition described herein may generate foam which expands for a total distance or achieve a total height of from at least 30 centimeters (cm), at least 40 cm, at least 50 cm, at least 1 meter (m), at least 1.2 m, at least 1.4 m, at least 1.6 m, at least 1.8 m, at least 2.0 m, at least 2.1 m, at least 2.2 m, at least 2.3 m, at least 2.4 m, at least 2.5 m, at least 2.6 m, at least 2.7 m, at least 2.8 m, at least 2.9 m, at least 3 m, at least 4 m, or at least 5 m, to about 6 m, about 7 m, about 8 m, about 9 m, about 10 m, about 15 m, or about 20 m. In certain embodiments, the disclosed pest control composition described herein may generate foam which expands for a total distance or achieve a total height of foam of at least 30 centimeters (cm), at least 40 cm, at least 50 cm, at least 1 meter (m), at least 1.2 m, at least 1.4 m, at least 1.6 m, at least 1.8 m, at least 2.0 m, at least 2.1 m, at least 2.2 m, at least 2.3 m, at least 2.4 m, at least 2.5 m, at least 2.6 m, at least 2.7 m, at least 2.8 m, at least 2.9 m, at least 3 m, at least 4 m, or at least 5 m, to about 6 m, about 7 m, about 8 m, about 9 m, about 10 m, about 15 m, or about 20 m in a vessel, such as in a pipe with a diameter of between about 1.0 and about 5.0 inches, or between about 1.0 and about 4.0 inches. In certain embodiments, the pipe has a diameter of about 1.25 inches or a diameter of about 3.8 inches.

In certain embodiments, the disclosed pest control composition described herein may generate foam with a total volume of at least 1000 mL³, at least 1100 mL³, at least 1200 mL³, at least 1300 mL³, at least 1400 mL³, at least 1500 mL³, at least 1600 mL³, at least 1700 mL³, at least 1800 mL³, at least 1900 mL³, at least 2000 mL³, to about 2500 mL³, to about 2600 mL³, to about 2700 mL³, to about 2800 mL³, to about 2900 mL³, to about 3000 mL³, to about 3500 mL³, or to about 4000 mL³. In certain embodiments, the disclosed pest control composition described herein may generate foam with a total volume of at least 1000 mL³, at least 1100 mL³, at least 1200 mL³, at least 1300 mL³, at least 1400 mL³, at least 1500 mL³, at least 1600 mL³, at least 1700 mL³, at least 1800 mL³, at least 1900 mL³, at least 2000 mL³, to about 2500 mL³, to about 2600 mL³, to about 2700 mL³, to about 2800 mL³, to about 2900 mL³, to about 3000 mL³, to about 3500 mL³, or to about 4000 mL³ in a vessel, such as in a pipe with a diameter of between about 1.0 and about 5.0 inches, or between about 1.0 and about 4.0 inches. In certain embodiments, the pipe has a diameter of about 1.25 inches or with a diameter of about 3.8 inches.

In certain embodiments, the foam generated by the pest control composition may comprise bubbles with an average maximum diameter of less than 20 mm, less than 15 mm, less than 14 mm, less than 13 mm, less than 12 mm, less than 10 mm, less than 9 mm, less than 8 mm, less than 7 mm, less than 6 mm, less than 5 mm, less than 4 mm, less than 3 mm, less than 2 mm, less than 1 mm, or less than 0.50 mm, down to about 0.01 mm, or about 0.001 mm. In some embodiments, the foam generated by the pest control composition may comprise bubbles with an average maximum diameter of about 2 mm to about 12 mm, or about 2 mm to about 6 mm. In certain embodiments, the foam generated by the pest control composition may comprise bubbles with an absolute maximum diameter of less than 20 mm, less than 15 mm, less than 14 mm, less than 13 mm, less than 12 mm, less than 10 mm, less than 9 mm, less than 8 mm, less than 7 mm, less than 6 mm, less than 5 mm, less than 4 mm, less than 3 mm, less than 2 mm, less than 1 mm, or less than 0.50 mm, down to about 0.01 mm. In some embodiments, the foam generated by the pest control composition may comprise bubbles with an absolute maximum diameter of about 2 mm to about 12 mm, or about 2 mm to about 6 mm. “Absolute maximum diameter” refers to the diameter of the single largest bubble generated by the pest control composition.

Anti-caking agent. Compositions in a dry form, such as a powder form, may have a tendency to lose their free-flowing properties. For instance, powdered products may become compacted or “caked” due to settling and/or their tendency for absorbing moisture from the ambient air. Caked products may be difficult to dispense from the container or into the application areas. Therefore, flow agents, such as anti-caking agents, are often added to powdered compositions in order to keep the powder free flowing. In addition, the anti-caking agent may keep the composition dry during storage and prevent chemical reactions from occurring between different components of the composition, elongating the shelf-life of the composition. In certain embodiments, the pest control composition disclosed herein remains in the powder form and has a shelf life of at least 2 years.

In certain embodiments, the pest control composition disclosed herein includes an anti-caking agent. Suitable anti-caking agents include, but are not limited to, starch, silica powders, grain flours, wood flour, talc, pumice, clays, and calcium phosphates. In certain embodiments, the anti-caking agent contains silica. Silica of different forms and sizes may be used. In certain embodiments, the anti-caking agent contains SIPERNAT 50s (hydrated silica).

The total amount of the anti-caking agent (e.g., the total amount of anti-caking in the composition) may be from about 0.5 wt. % to about 50 wt. %, from about 0.5 wt. % to about 40 wt. %, from about 0.5 wt. % to about 30 wt. %, from about 0.5 wt. % to about 20 wt. %, from about 1 wt. % to about 18 wt. %, from about 2 wt. % to about 16 wt. %, from about 2.5 wt. % to about 14 wt. %, from about 2.5 wt. % to about 12 wt. %, from about 3 wt. % to about 11 wt. %, from about 3 wt. % to about 10 wt. %, from about 4 wt. % to about 10 wt. %, from about 5 wt. % to about 10 wt. %, or from about 6 wt. % to about 10 wt. %. In certain embodiments, the total amount of the anti-caking agent may be about 6 wt. %. In certain embodiments, the total amount of the anti-caking agent may be about 7 wt. %. In certain embodiments, the total amount of the anti-caking agent may be about 8 wt. %. In certain embodiments, the total amount of the anti-caking agent may be about 9 wt. %. In certain embodiments, the total amount of the anti-caking agent may be about 10 wt. %.

In certain embodiments, the pest control composition includes a total amount of from about 0.5 wt. % to about 50 wt. % of SIPERNAT 50s. In certain embodiments, the pest control composition includes a total amount of from about 0.5 wt. % to about 40 wt. % of SIPERNAT 50s. In certain embodiments, the pest control composition includes a total amount of from about 0.5 wt. % to about 30 wt. % of SIPERNAT 50s. In certain embodiments, the pest control composition includes a total amount of from about 0.5 wt. % to about 20 wt. % of SIPERNAT 50s. In certain embodiments, the pest control composition includes a total amount of from about 1 wt. % to about 18 wt. % of SIPERNAT 50s. In certain embodiments, the pest control composition includes a total amount of from about 2 wt. % to about 16 wt. % of SIPERNAT 50s. In certain embodiments, the pest control composition includes a total amount of from about 2.5 wt. % to about 14 wt. % of SIPERNAT 50s. In certain embodiments, the pest control composition includes a total amount of from about 2.5 wt. % to about 12 wt. % of SIPERNAT 50s. In certain embodiments, the pest control composition includes a total amount of from about 3 wt. % to about 11 wt. % of SIPERNAT 50s. In certain embodiments, the pest control composition includes a total amount of from about 3 wt. % to about 10 wt. % of SIPERNAT 50s. In certain embodiments, the pest control composition includes a total amount of from about 4 wt. % to about 10 wt. % of SIPERNAT 50s. In certain embodiments, the pest control composition includes a total amount of from about 5 wt. % to about 10 wt. % of SIPERNAT 50s. In certain embodiments, the pest control composition includes a total amount of from about 6 wt. % to about 10 wt. % of SIPERNAT 50s. In certain embodiments, the pest control composition includes a total amount of about 6 wt. % of SIPERNAT 50s. In certain embodiments, the pest control composition includes a total amount of about 7 wt. % of SIPERNAT 50s. In certain embodiments, the pest control composition includes a total amount of about 8 wt. % of SIPERNAT 50s. In certain embodiments, the pest control composition includes a total amount of about 9 wt. % of SIPERNAT 50s. In certain embodiments, the pest control composition includes a total amount of about 10 wt. % of SIPERNAT 50s.

In certain embodiments, the total amount of essential oil and the total amount surfactant have a weight ratio of from about 2:1 to about 1:20. In certain embodiments, the total amount of essential oil and the total amount of surfactant have a weight ratio of from about 2:1 to about 1:15. In certain embodiments, the total amount of essential oil and the total amount of surfactant have a weight ratio of from about 1:1 to about 1:10. In certain embodiments, the total amount of essential oil and the total amount of surfactant have a weight ratio of from about 1:1 to about 1:8. In certain embodiments, the total amount of essential oil and the total amount of surfactant have a weight ratio of from about 1:2 to about 1:7. In certain embodiments, the total amount of essential oil and the total amount of surfactant have a weight ratio of from about 1:3 to about 1:6. In certain embodiments, the total amount of essential oil and the total amount of surfactant have a weight ratio of about 1:5. In certain embodiments, the essential oil may comprise mint oil and the surfactant may comprise sodium lauryl sulfate. In certain embodiments, the essential oil may comprise lemongrass oil and the surfactant may comprise sodium lauryl sulfate.

In certain embodiments, the total amount of foaming agent and the total amount of surfactant have a weight ratio of from about 100:1 to about 1:1. In certain embodiments, the total amount of foaming agent and the total amount of surfactant have a weight ratio of from about 90:1 to about 1:1. In certain embodiments, the total amount of foaming agent and the total amount of surfactant have a weight ratio of from about 60:1 to about 1:1. In certain embodiments, the total amount of foaming agent and the total amount of surfactant have a weight ratio of from about 50:1 to about 10:1. In certain embodiments, the total amount of foaming agent and the total amount of surfactant have a weight ratio of from about 50:1 to about 20:1. In certain embodiments, the total amount of foaming agent and the total amount of surfactant have a weight ratio of from about 40:1 to about 1:1. In certain embodiments, the total amount of foaming agent and the total amount of surfactant have a weight ratio of from about 40:1 to about 10:1. In certain embodiments, the total amount of foaming agent and the total amount of surfactant have a weight ratio of from about 40:1 to about 20:1. In certain embodiments, the total amount of foaming agent and the total amount of surfactant have a weight ratio of from about 40:1 to about 30:1. In certain embodiments, the total amount of foaming agent and the total amount of surfactant have a weight ratio of about 36.4:1. In certain embodiments, the total amount of foaming agent and the total amount of surfactant have a weight ratio of about 34.8:1. In certain embodiments, the foaming agent may comprise sodium bicarbonate and citric acid and the surfactant may comprise sodium lauryl sulfate.

In certain embodiments, the total amount of anti-caking agent and the total amount of surfactant have a weight ratio of from about 12:1 to about 1:6. In certain embodiments, the total amount of anti-caking agent and the total amount of surfactant have a weight ratio of from about 10:1 to about 1:5. In certain embodiments, the total amount of anti-caking agent and the total amount of surfactant have a weight ratio of from about 8:1 to about 1:4. In certain embodiments, the total amount of anti-caking agent and the total amount of surfactant have a weight ratio of from about 7:1 to about 1:3. In certain embodiments, the total amount of anti-caking agent and the total amount of surfactant have a weight ratio of from about 6:1 to about 1:2. In certain embodiments, the total amount of anti-caking agent and the total amount of surfactant have a weight ratio of from about 5:1 to about 1:1.5. In certain embodiments, the total amount of anti-caking agent and the total amount of surfactant have a weight ratio of from about 4.5:1 to about 1:1.2. In certain embodiments, the total amount of anti-caking agent and the total amount of surfactant have a weight ratio of from about 4:1 to about 1:1. In certain embodiments, the total amount of anti-caking agent and the total amount of surfactant have a weight ratio of about 2.4:1. In certain embodiments, the total amount of anti-caking agent and the total amount of surfactant have a weight ratio of about 4:1. In certain embodiments, the anti-caking agent may comprise SIPERNAT 50s (hydrated silica) and the surfactant may comprise sodium lauryl sulfate.

In certain circumstances, the composition may include one or more ingredients eligible for minimum risk pesticide products that are exempt from the Federal Insecticide, Fungicide, and Rodenticide Act (FIFRA) under the Minimum Risk Exemption regulations in 40 U.S. Code of Federal Regulations 152.25(f), for example, included, but not limited to, those listed as “Active Ingredients Permitted in Exempted Minimum Risk Pesticide Products” in 40 U.S. Code of Federal Regulations 152.25(f).

In certain embodiments, the pest control composition described herein is substantially free of water. In certain embodiments, the pest control composition is free of water.

In certain embodiments, the pest control composition disclosed herein is in a powder form and has an average particle size of more than 1000 nm, more than 1500 nm, more than 2000 nm, or more than 3000 nm.

In certain embodiments, the disclosed pest control composition described herein may achieve at least 40%, at least 50%, at least 55%, at least 60%, at least 65%, at least 70%, at least 75%, at least 80%, at least 85%, at least 90%, at least 95%, or at least 99% coverage of the pipe wall area or the pipe space within the drain being treated.

In certain embodiments, the disclosed pest control composition described herein may achieve at least 30 seconds, at least 40 seconds, at least 50 seconds, at least 1 minute, at least 5 minutes, at least 10 minutes, at least 15 minutes, at least 20 minutes, at least 25 minutes, at least 30 minutes, at least 40 minutes, at least 50 minutes, or at least 1 hour, up to about 10 hours, or about 5 hours of contact time with the insects and/or larvae on a non-horizontal surface.

In certain embodiments, the pest control composition described herein may achieve a pest mortality rate of at least 50%, at least 55%, at least 60%, at least 65%, at least 70%, at least 75%, at least 80%, at least 85%, at least 90%, at least 95%, least 99%, or 100% 1 DAT, 2 DAT, 3 DAT, 4 DAT, 5 DAT, 6 DAT, 7 DAT, 8 DAT, 9 DAT, 10 DAT, 11 DAT, 12 DAT, 13 DAT, 14 DAT, 15 DAT, or 16 DAT. In certain embodiments, mortality rate may be evaluated using the emergence rate from larvae to adulthood of the pests being treated. In certain embodiments, the pests comprise sewer flies, drain flies, and/or fruit flies (e.g., red fruit flies). In certain embodiments, the pest control composition described herein may achieve a mortality rate of 100% against red fruit flies 16 DAT. In certain embodiments, the pest control composition described herein may achieve a mortality rate of about 80%, about 85%, about 90%, about 95%, about 99%, or 100% against sewer flies or drain flies (Clogmia albipunctata) 1 DAT, 2 DAT, 3 DAT, 4 DAT, 5 DAT, 6 DAT, 7 DAT, 8 DAT, 9 DAT, 10 DAT, 11 DAT, 12 DAT, 13 DAT, 14 DAT, 15 DAT, or 16 DAT. In certain embodiments, the pest control composition described herein may achieve a mortality rate of about 80%, about 85%, about 90%, about 95%, about 99%, or 100% against fruit flies (Drosophila hydei) 1 DAT, 2 DAT, 3 DAT, 4 DAT, 5 DAT, 6 DAT, 7 DAT, 8 DAT, 9 DAT, 10 DAT, 11 DAT, 12 DAT, 13 DAT, 14 DAT, 15 DAT, or 16 DAT.

In certain embodiments, the pest control composition described herein may achieve commercially acceptable level of mortality rate after a short exposure period with the pests. In certain embodiments, the pest control composition may achieve a pest mortality rate of at least 50%, at least 55%, at least 60%, at least 65%, at least 70%, at least 75%, at least 80%, at least 85%, at least 90%, at least 95%, at least 99%, or 100% 1 DAT, 2 DAT, 3 DAT, 4 DAT, 5 DAT, 6 DAT, 7 DAT, 8 DAT, 9 DAT, 10 DAT, 11 DAT, 12 DAT, 13 DAT, 14 DAT, 15 DAT, or 16 DAT with a 15-minute, a 30-minute, or a 1-hour exposure with pests. In certain embodiments, the pests comprise sewer flies, drain flies, and/or fruit flies (e.g., red fruit flies). In certain embodiments, the pest control composition described herein may achieve a mortality rate of 100% against red fruit flies 16 DAT with a 15-minute exposure.

In certain embodiments, the pest control composition described herein may achieve less than 70%, less than 60%, less than 50%, less than 40%, less than 30%, less than 25%, less than 20%, less than 15%, less than 10%, less than 5%, less than 1%, or 0% of emergence rate from larvae to adulthood of the pests 1 DAT, 2 DAT, 3 DAT, 4 DAT, 5 DAT, 6 DAT, 7 DAT, 8 DAT, 9 DAT, 10 DAT, 11 DAT, 12 DAT, 13 DAT, 14 DAT, 15 DAT, or 16 DAT with a short exposure period with the pests, such as a 15-minute, a 30-minute, or a 1-hour exposure. In certain embodiments, the pests comprise sewer flies, drain flies, and/or fruit flies (e.g., red fruit flies). In certain embodiments, the pest control composition described herein may achieve a 0% emergence rate from larvae to adulthood of red fruit flies 16 DAT with a 15-minute exposure.

In certain embodiments, the pest control composition described herein allows for a more efficient flushing of the pest away from a treated area, such as from a sink trap. The pest may be attached to a rope, or may be embedded in a rearing media, which makes regular flushing with water less efficient. In certain embodiments, the pest control composition described herein may achieve a more efficient flushing by lifting the pest (e.g., larvae) out of the vessel through foaming action. In certain embodiments, the pest control composition described herein may achieve at least 50%, at least 55%, at least 60%, at least 65%, at least 70%, at least 75%, at least 80%, at least 85%, at least 90%, at least 95%, at least 99%, or 100% flushing of the pest trapped in a test vessel (e.g., a kitchen sink or a drain pipe). In certain embodiments, the pest control composition described herein achieves 95%, 99%, or 100% flushing of the pest trapped in a test vessel (e.g., a kitchen sink). In certain embodiments, the pests comprise sewer flies, drain flies, and/or fruit flies (e.g., red fruit flies).

In certain embodiments, the pest control composition described herein may be prepared by mixing the components using a mixer (e.g., kitchen mixer or paddle mixer) at various scales.

Another aspect of the present application provides a method of treating pests in a drain pipe system. The method comprises introducing to the drain pipe system a powder pest control composition comprising at least one essential oil; a foaming agent; an anti-caking agent; and a surfactant; and the method comprises activating the pest control composition by adding an amount of water to the drain pipe system effective to cause the pest control composition to react and generate a foam before or after the introduction of the pest control composition; whereby the foam generated expands within the drain pipe system and comes in contact with the pests in the drain; and allowing the foam to remain in contact with the pests in the drain for a sufficient time.

The methods disclosed herein may be effective against insects residing in a drain and the larvae thereof, such as fruit flies, drain flies, or sewer flies.

Any of the embodiments described herein may be modified to include any of the structures, compositions, or methodologies disclosed in connection with different embodiments.

### EXAMPLES

The following Examples are provided to demonstrate and further illustrate certain embodiments and aspects of the present disclosure and are not to be construed as limiting the scope of the disclosure.

In certain embodiments, as will be illustrated through the Examples, the pest control composition provides a pest mortality rate of at least 60%, at least 70%, at least 80%, at least 90%, at least 95%, at least 99%, or 100% of the insects and/or the larvae thereof. In certain embodiments, the pest control composition provides less than 70%, less than 60%, less than 50%, less than 40%, less than 30%, less than 25%, less than 20%, less than 15%, less than 10%, less than 5%, less than 1%, or 0% of emergence rate from larvae to adulthood of the pests being treated.

Unless stated otherwise, the efficacy tests were conducted in accordance with the U.S. Environmental Protection Agency Product Performance Test Guidelines, OCSPP 810.3500: Premises Treatments, which provides recommendations for the design and execution of laboratory and field studies to evaluate the performance of pesticide products applied in or around premises in connection with registration of pesticide products under the Federal Insecticide, Fungicide, and Rodenticide Act (FIFRA) (7 U.S.C. 136, et seq.). The entire contents of these testing guidelines are incorporated by reference herein.

In general, the following data was recorded for each sample set: sample group size, genus species, sex, maturity and general condition. Number of insects dead and/or number of survival insects were also recorded. The conditions of the testing area (temperature, humidity, date and time) were also associated with each testing round of samples and control. Additionally, the mortality results (e.g., % emergence from larvae to adulthood) were reported in both number relative to sample size and as a percentage of the sample size.

### Example 1

Several formulations according to embodiments of the present disclosure were tested and efficacy data, including knockdown and mortality data, was collected for the formulations.

Ingredients in Table 1 were used to prepare the powder-based formulations (i.e., Foam A and Foam B) and gel-based (i.e., Gel A and Gel B) formulations. Table 2 summarizes the efficacy of multiple formulations in terms of percentage survival of red fruit flies. Powder-based formulations were compared against gel-based formulations and a commercial formulation (i.e., Green Gobbler® by GG Buyer, LLC). Tests were run with 15-minute exposure with the treated area containing larvae before rinsing with water, which is significantly shorter than the recommended exposure time (e.g., at least 4 hours, at least 8 hours, or overnight) of commercial products currently on the market.

TABLE 1
Components of powder-based formulations
and comparative formulations

| | | | | |
|---|---|---|---|---|
| | | | | Green |
| Foam | Foam | Gel | Gel | Gob- |
| A | B | A | B | bler ® |

| | | | | |
|---|---|---|---|---|
| Active | Mint Oil | Lemongrass | Mint | Lemongrass |
| Component | | Oil | Oil | Oil |
| Surfactant | SLS | SLS | SLS | SLS |
| Foaming | Sodium | Sodium | N/A | N/A |
| Agent 1 | bicar- | bicar- | | |
| | bonate | bonate | | |
| Foaming | Citric | Citric | N/A | N/A |
| Agent 2 | Acid | Acid | | |
| Anti-caking | SIPERNAT | SIPERNAT | N/A | N/A |
| Agent | 50S | 50S | | |

TABLE 2
Efficacy data of powder-based formulations and comparative
formulations against red fruit flies.

| | | Controls | | | Green | | |
|---|---|---|---|---|---|---|---|
| | DAT | (Untreated) | Foam A | Foam B | Gobbler ® | Gel A | Gel B |
| Percentage | 7 | 0% | 0% | 0% | 5% | 10% | 10% |
| of Adult Red | 8 | 5% | 0% | 0% | 8% | 20% | 23% |
| Fruit Fly | 9 | 28% | 0% | 0% | 20% | 35% | 23% |
| Emergence | 10 | 50% | 8% | 0% | 25% | 43% | 30% |
| from Larvae | 11 | 68% | 13% | 0% | 30% | 58% | 40% |
| | 12 | 80% | 13% | 0% | 35% | 60% | 45% |
| | 13 | 85% | 13% | 0% | 38% | 60% | 45% |
| | 14 | 85% | 13% | 0% | 38% | 60% | 45% |
| | 15 | 88% | 13% | 0% | 38% | 60% | 45% |
| | 16 | 88% | 13% | 0% | 38% | 60% | 45% |

Table 3 shows two power-based formulations containing the components identified in Table 1. These formulations have shown superior efficacy in the preliminary tests against insects.

TABLE 3
Components and weight ranges of powder-based formulations.

| | Formulation 1 | Formulation 2 |
|---|---|---|
| Ingredient | (wt. %) | (wt. %) |
| Lemongrass Oil | 0.5 | 0.5 |
| Sodium Lauryl | 2.5 | 2.5 |
| Sulfate (>95%) | | |
| Sodium | 56 | 54 |
| Bicarbonate | | |
| Citric Acid, | 35 | 33 |
| Anhydrous USP | | |
| SIPERNAT 50S | 6 | 10 |

Powder-based formulation Foam B showed exceptional performance with 0% survival rate of red fruit flies 16 days after application. Foam A also showed excellent performance comparing to the three comparative formulations, with 13% survival rate of red fruit flies 16 days after application. The comparative examples here highlighted the synergistic advantages achieved by the powder-based compositions between the active component and the foaming effect, as well as asphyxiation of the larvae by the generated CO₂.

### Example 2

The two formulas in Table 3 were tested for larvicidal efficacy. Both formulas were tested for fruit flies and drain flies under two different sets of test conditions, outlined in the 4 studies below.

### Study 1: Mortality Efficacy of Test Formulations Against Drain Fly Larvae in Simulated Sink Drains in a Laboratory.

### Purpose

Provide mortality efficacy data for two foaming test formulations against drain fly larvae in simulated sink drains in a laboratory environment.

### Overview

Drain fly larvae in p-traps of sink and drain assemblies were exposed to powdered test formulations and tap water in a manner consistent with proposed label use instructions. At the end of the treatment exposure period, drains were flushed with tap water; and nutrient water with fish flakes was added to ensure any remaining larvae did not starve. Control replicates had 8 oz of water and the same amount of activation and flush water poured through their drain apparatus as the test replicates. Daily mortality observations were taken for 3 days. On the final day, drains were disassembled for final mortality counts. The two test formulations killed 85 to 87% of larvae and supports a label claim that the tested substance kills drain fly larvae in drains.

### Test System

Identify: Drain Flies (Clogmia albipunctata) (A.K.A. Sewer flies, Sewer gnats, Filter flies, Sink flies, Moth flies)
Strain: N/A
Age: Larvae
Sex: Unsexed
Resistance: Non-resistant

### Test Substances:

Formulations 1 and 2 from Table 3.

### Control Substance

Eight fluid ounces of tap water was used to treat the control drains.

### Dosing

Measured doses of 55 g of powder were weighed for each replicate. Exact weights were recorded.

### Pre-Treatment Rearing Condition

When applicable, test systems were provided with adequate food, water and harborage under controlled temperature and humidity conditions.

### Control of Bias

A population of only healthy vigorous test systems was selected for this study. Test systems with aberrant behavior of appearing unhealthy were avoided.

### Justification for Selection of Test System

Drain flies are targeted insects on the label of the test substances. They are an important pest insect throughout the United States and globally. They are readily and reliably reared in a laboratory setting, which allows testing to be performed under controlled and reproducible conditions.

### Materials

A. Test Substances as listed above in Test Substances
B. Test Systems, 10 per replicate, species listed above in Identification of the Test Systems
C. Test apparatus and materials: Simulated washroom sink apparatus consisting of:
   1. Clear glass or plastic sink bowls
   2. Clear drain assembly, 1½″ diameter
   3. Clear p-trap, 1½″ diameter
   4. 90° elbow, 1½″ diameter
   5. Drain waistline arm, 1½″ diameter
   6. Cotton clothesline substrate (conditioned/aged in nutrient water)
   7. Mesh fabric to prevent test systems from being washed out of the testing apparatus during treatment and/or flushing
   8. Laboratory stands with clamp arms to hold sink/drain apparatus upright.
D. 1 & 3-gallon plastic buckets to hold flushing water and catch flushed water and treatments
E. Soft forceps for transferring test systems
F. Stopwatches/countdown timers
G. Data sheets
H. Permanent Pen
I. Tape and Marker for labeling
J. Graduated beakers to measure volumes of water and nutrient water
K. A calibrated balance which weighs within 0.01 g. The appropriate SOP for the balance will be followed. The balance identification number will be documented in the raw data
L. Weight set for checking the calibration of the balance
M. Nutrient water: (Guinea pig chow, Wheat Germ)
N. Tetramin Fish flakes
O. Plastic transfer cups such as 002C from Pioneer plastics
P. Plastic rearing cups such as 115b from Pioneer plastics
Q. 30 and 60 mesh sieves
R. Turkey baster
S. Tap water, cool/room temperature
T. Graduated beaker/measuring cup
U. Funnel

### Method

### A. Test Design:

1. Five replicates were run for each test substance and controls.
2. Each replicate contained 10 test systems.
3. Mortality counts taken daily for 3 days after treatment.

### B. Preparation:

1. Lengths of approximately 18″ long cotton rope were “conditioned” by soaking them for several days to a week in nutrient water.
2. Built a sink/drain apparatus for each test and control replicate.
3. Aside from the normal sink/drain construction, an extra 90° elbow was added to raise the mesh containment membrane above the standing water level so larvae did not drown on that side of the p-trap, and therefore any cause of mortality could be attributed to test substances rather than drowning.
4. A length of conditioned cotton clothesline substrate was “snaked” through each drain apparatus so that the drain fly larvae have something to crawl on, as the larvae are not truly 100% aquatic, and need something to cling to and walk along to prevent drowning/exhaustion. Growth on the rope from its conditioning is also a source of food for the larvae.
5. Inserted mesh across pipe at the tail end of the 90° elbow after the p-trap to contain larvae during treatment and flushes. The elbow raised the mesh above the standing water level. Mesh held in place by threading the drain waste-line arm, in place.
6. Test system set-up took place the day before test substance application.
   a. Emptied rearing cup contents into a 30-mesh sieve over a 60-mesh sieve.
   b. Rinsed cup with cool water to get all contents out.
   c. Rinsed larvae from mesh back into the clean larval cup or similar with clean shallow water (˜1″ deep)
   d. Transported test systems from insectary to testing area.
   e. When healthy wriggling larvae were seen, gently picked them up with soft forceps and placed them into a small transfer cup with cool/room temp tap water.
   f. Selected 10 larvae for the transfer cup.
   g. Using a turkey baster, gently transferred the test systems from the transfer cup to a sink/drain arena replicate.
   h. Flushed with a bit of extra water if larvae get stuck alongside the pipe wall or on the rope above the p-trap water level.
   i. Repeated until all sink/drain arenas replicates have received their test systems.
   j. Allowed the test systems to acclimate overnight.

### C. Test Procedure:

1. Ensure test systems look healthy after overnight acclimation.
2. Measure 55 g of test substance powder into a cup and recorded the actual weight.
   a. Product sachets will contain measured doses of 55 g of test substance.
3. Place funnel in drain opening of sink.
4. Pour measured test substance powder through the funnel into the drain.
5. For Control replicates, add 8 oz of cool/room temperature tap water instead of measured powder.
6. Immediately after adding powder (or control water), start countdown timer set for 1-hour.
7. At the 5-minute mark, add 4 oz of cool or room temperature tap water.
8. After adding the 4 oz of water to a replicate, start the next replicate.
9. Repeat until all test replicates have been treated.
10. When the 1 hr timer finishes, pour approximately 1 gallon of water into the sink/drain apparatus.
11. 24-Hour mortality counts:
   a. Mortality observation counts consist of three classifications:
      1) Alive Test systems—defined as experiencing no affects from the treatment.
      2) Dead Test systems—defined as not moving even after prodding.
      3) Moribund test systems—defined as experiencing some aberrant behavior such as: on their back or side, unable to maintain a normal posture and/or excessive leg twitching or similar involuntary movements, or lethargy of a test system experiencing affects from the treatment.
   b. Observed test systems and documented numbers alive, dead, and moribund at 24±4 hrs, 48±4 hrs, & 72±4 hrs for both the test substance and untreated controls.
   c. The 72 hr mortality observation involved dismantling the drain apparatus, and then pouring their contents through a 30-mesh and 60-mesh sieve to get a more accurate count of numbers and condition of test systems.
12. Following the final hour mortality counts, disposed of test insects with scalding hot water and a garbage disposal.
13. Test apparatus was washed by hand with a dish soap and scrub brushes.

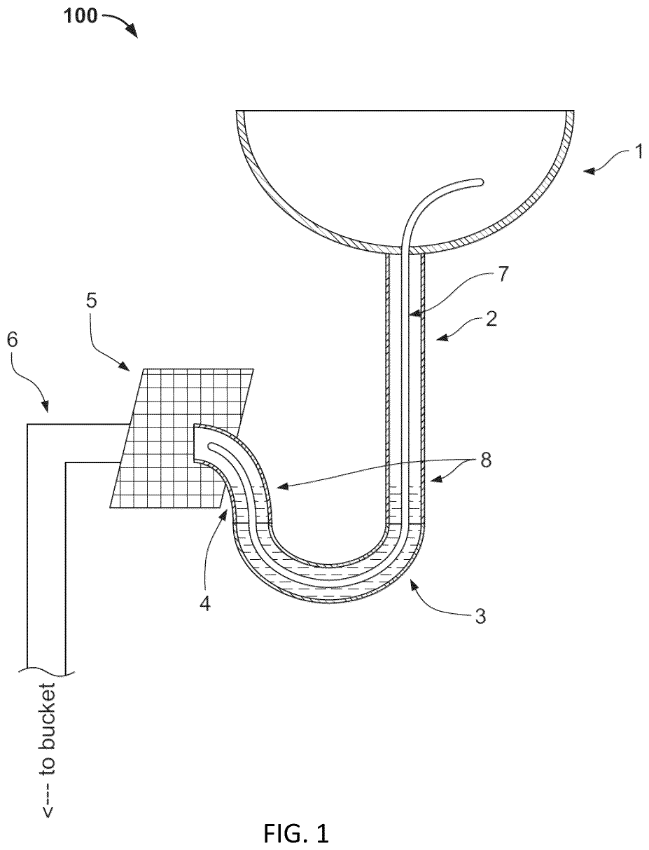

A diagram of the test apparatus (100) is shown in FIG. 1 with water level (8) indicated, which includes a sink (1), a drain assembly (2), a p trap (3), an extra 90° elbow (4), a fabric mesh (5), and a drain wasteline arm (6) that drains into a bucket. The apparatus further includes a cotton rope (7).

### Data Calculations & Transformations

Percent mortality, median, and means were determined for test substances and untreated control using Microsoft Excel. Abbott's formula for correcting mortality was applied to the mean mortalities of the test substances and calculated in Excel.

Abbott's formula: 1−((1−Test mortality)/((1−Control mortality)).

### Results and Discussion

Table 4 shows mean gram amount of the two test substances measured, mean daily mortality, percent of test systems observed daily, and median final mortality observations.

TABLE 4
Efficacy against sewer flies (Clogmia albipunctata)

| | Mean Grams of Test | 72 hr Median | Corrected 72 hr |
|---|---|---|---|
| Treatment | Substance | Mortality | Mean Mortality |
| Water Control | n/a (8 oz water) | 10.0% | 8.0%* |
| Formulation 1 | 55.05 | 81.8% | 85.1% |
| Formulation 2 | 55.01 | 81.8% | 87.2% |

Mean mortalities for test substances corrected with Abbott's formula
*No correction needed for control

Observed mortalities on days 1 and 2, found in the hard data, are not presented in Table 4 because many of the larvae were hidden from view so not observable; therefore, they were incomplete readings and statistical data using those numbers would be inconclusive. They were used more as a measure of progress for the test.

Both powder formulations have the same median mortality, 81.8%, which indicates their similar efficacy. The final (72 hr) mean mortality results presented in Table 4 demonstrate that both formulations tested kill drain fly larvae in a simulated drain p-trap within 3 days. At least 85% of the larvae were removed from the drains. Control mortality of 8% demonstrates that water flushing alone is not enough to kill drain fly larvae.

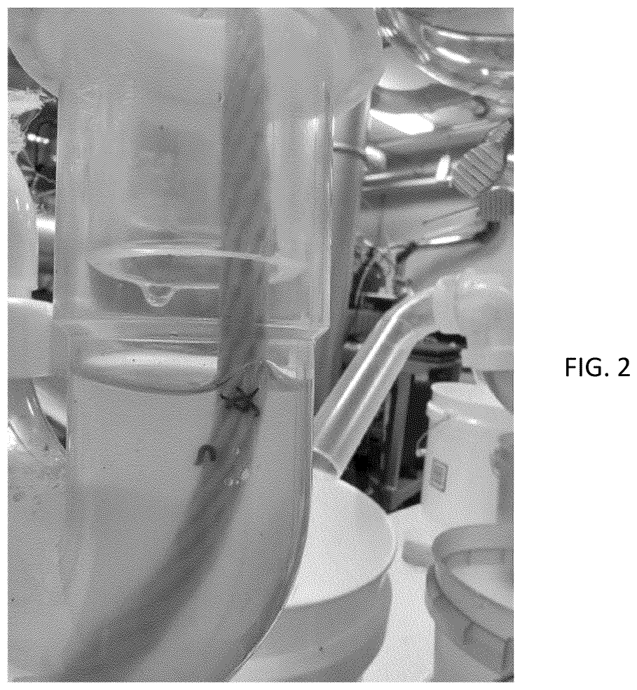

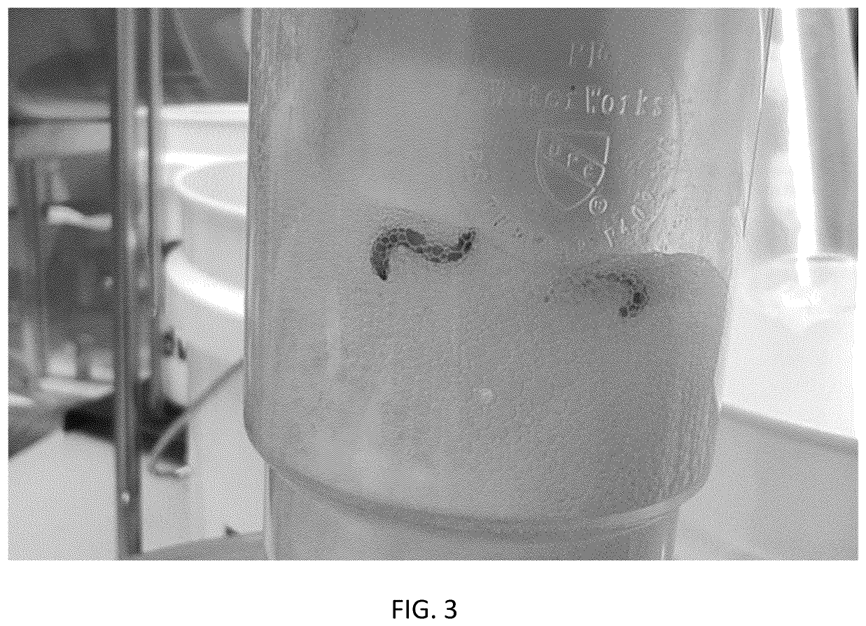

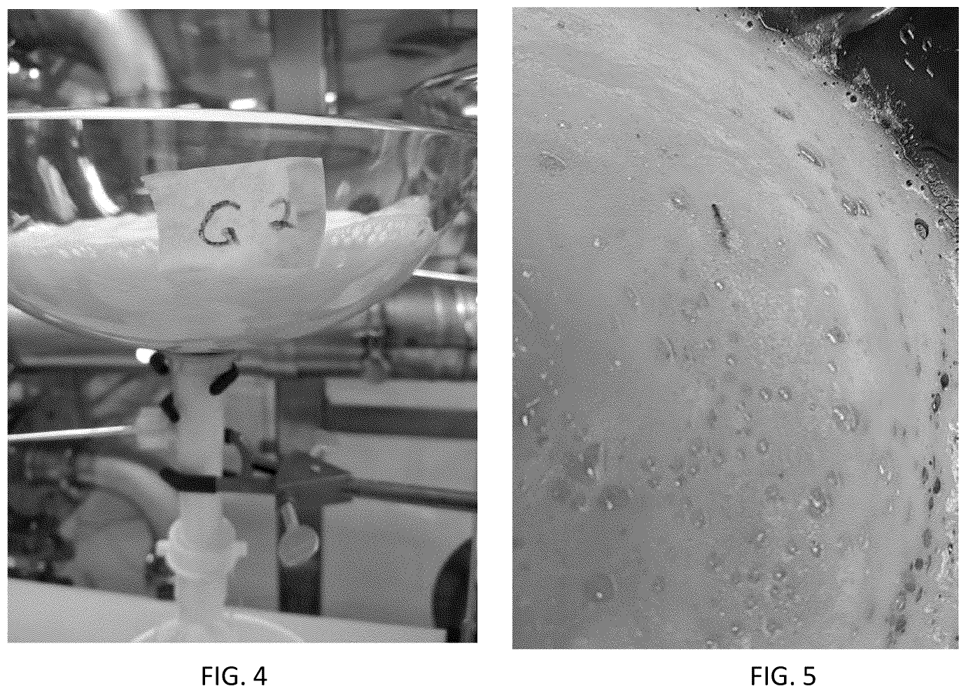

FIGS. 2-5 show some of the experiment photos.

### Environmental Conditions

Study was conducted in a laboratory held at a temperature of 80±2° F. (27±1° C.), and relative humidity of 50%±20; and artificial lighting on timers set for 14 hrs on, 10 hrs off.

### Proposed Label Instructions/Directions for Use

1. Remove sink or drain strainer if present.
2. Run water through drain for 30 seconds prior to treatment.
3. Tear open top of one pouch and pour entire contents into the drain.
4. Run water for 3 seconds to ensure foaming, let rest for one hour, then rinse with water.
5. Wash hands after handling. Repeat weekly until problem is resolved. Do not use more than once per day.

### Study 2: Mortality Efficacy of Test Formulations Against Fruit Fly Larvae in Simulated Sink Drains in a Laboratory.

### Purpose

Provide mortality efficacy data for two foaming test formulations against fruit fly larvae in simulated sink drains in a laboratory environment.

### Overview

Fruit fly larvae in drain assemblies were exposed to powdered test formulations and tap water and flushed with tap water at end of the treatment exposure period, all in a manner consistent with label usage instructions. Control replicates used 4 oz of water as the control substance, and the same amounts of activation and flush water poured through the sink apparatus. Drain assemblies were monitored daily for adult emergence for 15 days. The drain assemblies were disassembled on the 15th day after treatment for to look for any extra adults that could not be found/seen in previous observations to achieve a more accurate final count. Both formulations killed over 95% of larvae in treated drains supporting label claims that it will kill fruit fly larvae in sink drains.

### Test System

Identity: Fruit flies (Drosophila hydei) (A.K.A. Vinegar flies)
Strain: N/A
Age: Larvae
Sex: Unsexed
Resistance: Non-resistant

### Test Substances:

Formulations 1 and 2 from Table 3.

### Control Substance

Four fluid ounces of tap water was used to treat the control drains.

### Dosing

Measured doses of 55 g of powder were weighed for each replicate. Exact weights were recorded.

### Pre-Treatment Rearing Condition

When applicable, test systems were provided with adequate food, water and harborage under controlled temperature and humidity conditions.

### Control of Bias

A population of only healthy vigorous test systems was selected for this study. Test systems with aberrant behavior of appearing unhealthy were avoided.

### Justification for Selection of Test System

Fruit flies are targeted insects on the label of the test substances. They are an important pest insect throughout the United States and globally. They are readily and reliably reared in a laboratory setting, which allows testing to be performed under controlled and reproducible conditions.

### Materials

A. Test Substances as listed above in Test Substances
B. Test Systems, 25 per replicate, species listed above in Identification of the Test Systems
C. Test apparatus materials: Simulated washroom sink apparatus consisting of:
   a. Clear glass or plastic sink bowls
   b. Clear drain assembly, 1½″ diameter
   c. Extra drain extension, 1½″ diameter
   d. Clear p-trap, 1½″ diameter
   e. Clear Drain waistline arm, 1½″ diameter
   f. Mesh fabric to prevent test systems from being washed out of the testing apparatus during treatment and/or flushing
   g. 90° Drain Elbow, 1½″ diameter
   h. Laboratory stands with clamp arms to hold sink/drain apparatus upright.
D. 1 & 3-gallon plastic buckets to hold flushing water and catch flushed water and treatments
E. Soft forceps for transferring test systems
F. Stopwatches/countdown timers
G. Data sheets
H. Permanent Pen
I. Tape and Marker for labeling
J. Graduated beakers to measure volumes of water and nutrient water
K. A calibrated balance which weighs within 0.01 g. The appropriate SOP for the balance will be followed. The balance identification number will be documented in the raw data
L. Weight set for checking the calibration of the balance
M. Plastic transfer cups such as 002C from Pioneer plastics
N. Plastic rearing cups such as 115b from Pioneer plastics
O. 30-mesh and 60-mesh sieves
P. Tap water
Q. Graduated beaker/measuring cup
R. Funnel
S. Microwave
T. Plastic tube approximately 1″ diameter
U. Metal rod approximately ½″ diameter
V. Fruit fly media
W. Filter papers 55 mm diameter
X. Extra compression rings
Y. Metal spatula

### Method

### A. Test Design:

1. Five replicates were run for each test substance and controls.
2. Each replicate contained 25 test systems.
3. Adult emergence counts were taken daily for 15 days post treatment.

### B. Preparation:

1. Built a sink/drain apparatus for each test and control replicate.
2. Aside from the normal sink/drain construction, an extra 90° elbow was added to raise the mesh containment membrane above the standing water level so larvae did not drown on that side of the p-trap, they would have the opportunity to crawl above the waterline, and therefore mortality could be attributed to test substances rather than drowning.
3. Inserted mesh across pipe at the tail end of the 90° elbow after the P-trap to contain larvae during treatment and flushes. The extra elbow raised the mesh above the standing water level. Mesh held in place by threading the drain waste-line arm in place.
4. Test system set-up took place the day before test substance application.
   a. Test systems were set up inside additional extension tubes which were placed between the p-trap and sink drain assembly.
   b. The inside walls of the extra extension tube were completely coated/spackled fruit fly larval media from the bottom of the tube to 2″ from the top threads for an effective length of 4″ of coated tube. This replicated the wall build up that would occur in a home sink, and where the fruit fly larvae would normally develop.
      1. Measured 75 mL of filtered water
      2. Boiled water in microwave
      3. Added 50 mL of powdered fruit fly media mix
      4. Stirred with metal spatula
      5. Pushed drain extension tube onto the hot pliable media to compact the media up into the entirety of the extension tube.
      6. Once tube was filled, used long 1″ diameter hollow plastic tube to cut out a hole from the inside length of the media packed extension tube.
      7. Used metal rod to push the media out of the hollow plastic tube for next use.
      8. Used spatula to spackle in leftover media to any spots along the wall that needed repairing.
      9. Allowed media to cool (by time finished adding media to tubes, first completed tubes were cooled).
   c. Added fruit fly larvae
      1. Pulled excelsior wood wool from fruit fly culture.
      2. Dipped excelsior into shallow water in a plastic dish to dislodge larvae.
      3. Used soft forceps to select and transfer larvae from water into the media-spackled extension tubes.
      4. Once 25 larvae were counted into a tube, each end was sealed with parafilm.
   d. Larvae were allowed to acclimate overnight with tubes resting on their sides.
5. The next day, parafilm was removed and larvae were inspected for health.
6. Once a tube was deemed acceptable, p-traps were filled and extension tubes with media and fruit fly larvae were assembled into the laboratory sink assemblies.

### C. Test Procedure:

1. Measure 55 g of test substance powder into a cup and recorded the actual weight.
2. Place funnel in drain opening of sink.
3. Pour measured test substance powder through the funnel into the drain.
4. For Control replicates, add 4 oz of cool/room temperature tap water instead of measured powder.
5. Immediately after adding powder (or control water), start countdown timer set for 1-hour.
6. At the 5-minute mark, add 4 oz of cool or room temperature tap water.
7. After adding the 4 oz of water to a replicate, start the next replicate.
8. Repeat until all test replicates have been treated.
9. When the 1 hr timer finishes, pour approximately 2 liters of cool/room temperature water into the sink/drain apparatus.
10. Placed a round filter paper over the sink drain opening and weighed it down with extra plastic compression seals to prevent adults from emerging and escaping without being counted. The filter paper also allowed some breathing for the tube, to prevent buildup of gasses from normal fermentation/decomposition of the media.
11. Daily adult emergence counts:
   a. Observed test systems daily.
   b. If live adults were seen, the sides of the drain apparatus were gently tapped to encourage them to climb upward (they are gravitropic).
   c. Once they emerged from the top of the drain, they could be collected and removed from the test arena to ensure they would not be double counted.
   d. Recorded number seen and number collected/removed.
   e. Each test and control sink had its own cup to keep collected adults and get an accurate final count.
   f. Took adult emergence counts for 15 days following the start of the test.
12. The final adult emergence count involved dismantling each sink drain apparatus and flushing water and media through a 30-mesh and 60-mesh sieve to look for any additional larvae or adults (alive or dead).
   a. Dead adults found on the last day were counted as emerged.
13. Following the final mortality counts, disposed of test insects with scalding hot water and a garbage disposal.
14. Test apparatus was washed by hand with a dish soap and scrub brushes.

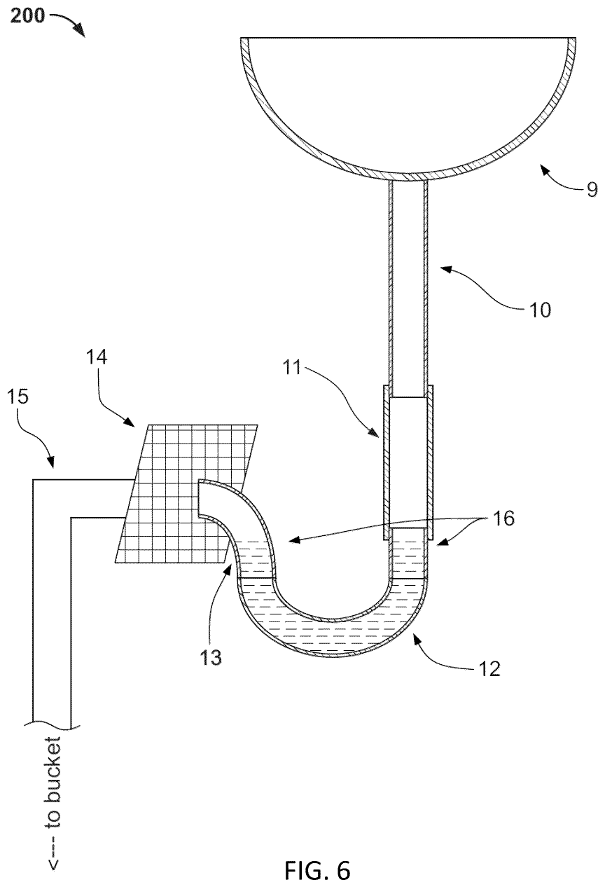

A diagram of the test apparatus (200) is shown in FIG. 6 with water level (16) indicated, which includes a sink (9), a clear drain assembly (10), an opaque extra drain tube extension (11) with larval media along interior walls, a clear p trap (12), an extra elbow (13), a fabric mesh (14), and a drain wasteline arm (15) that drains into a bucket.

### Data Calculations & Transformations

Mean percentages of emerged adults, final mean percent mortalities, and median percent mortalities were determined for test substances and untreated control using Microsoft Excel. Abbot's formula for correcting treated mortalities was used and calculated in Excel. Mortality was determined by the difference between the total number of infested larvae minus the emerged adults. In cases where more adults emerged than were, the n was adjusted to reflect the number found/collected.

Abbott's formula: 1−((1−(% Test mortality)/(1−(% Control mortality)). Percent mortalities expressed as decimals within formula.

### Results and Discussion

Table 5 shows mean amounts of the two test substances applied and the cumulative daily mean percent adult emergence of test systems.

TABLE 5
Efficacy against fruit flies (Drosophila hydei)

| | | Uncorrected Daily Cumulative Mean Percent of Adult | | | | | | | | | |
|---|---|---|---|---|---|---|---|---|---|---|---|
| | | Emergence | | | | | | | | | |
| | | Days | | | | | | | | | |
| | Mean | 1-6 | | | | | | | | | |
| | Grams | (24 hrs- | | | | | | | | | |
| | of Test | 144 | Day | Day | Day | Day | Day | Day | Day | Day | Day |
| Treatment | Substance | hrs) | 7 | 8 | 9 | 10 | 11 | 12 | 13 | 14 | 15 |
| Water | n/a (4 oz | 0.0% | 0.7% | 0.7% | 6.8% | 20.3% | 58.5% | 70.7% | 72.1% | 72.8% | 73.6% |
| Control | water) | | | | | | | | | | |
| Formulation 1 | 55.002 | 0.0% | 0.0% | 0.0% | 0.0% | 0.0% | 0.0% | 0.0% | 0.0% | 2.4% | 3.2% |
| Formulation 2 | 55.002 | 0.0% | 0.0% | 0.0% | 0.0% | 0.8% | 0.8% | 0.8% | 2.4% | 2.4% | 3.2% |

Table 6 shows median percent mortality and corrected mean percent mortality for the two formulations.

TABLE 6
Efficacy against fruit flies (Drosophila hydei)

| | Final Median | Abbott's Corrected |
|---|---|---|
| Treatment | Percent Mortality | Mean Mortality |
| Water Control | 18.0% | 26.4%* |
| Formulation 1 | 96.0% | 95.7% |
| Formulation 2 | 96.0% | 95.7% |

Mean mortalities for test substances corrected with Abbott's formula
*No correction needed for control

Water flushing alone was not enough to achieve acceptable efficacy as demonstrated by the 26.4% mean water control mortality.

Both powder formulations have the same median mortality of 96.0%, which indicates their similar efficacy. The final and identical corrected mean percent mortalities of 95.7% for the two formulations demonstrate that both formulations tested effectively kill fruit fly larvae in drains when used as directed.

### Environmental Conditions

Study was conducted in a laboratory held at a temperature of 80±2° F. (27±1° C.), and relative humidity of 50%±20; and artificial lighting on timers set for 14 hrs on, 10 hrs off.

### Proposed Label Instructions/Directions for Use

1. Remove sink or drain strainer if present.
2. Run water through drain for 30 seconds prior to treatment.
3. Tear open top of one pouch and pour entire contents into the drain.
4. Run water for 3 seconds to ensure foaming, let rest for one hour, then rinse with water.
5. Wash hands after handling. Repeat weekly until problem is resolved. Do not use more than once per day.

### Study 3: Flushing Efficacy of Test Formulations Against Drain Fly Larvae in Simulated Sink Drains in a Laboratory.

### Purpose

Provide flushing efficacy data for foaming test formulations against drain fly larvae in a sink drain in a laboratory environment.

### Overview

Drain fly larvae in p-traps of sink and drain assemblies were exposed to powdered test formulations and tap water in a manner consistent with proposed label use instructions. At the end of the treatment exposure period, drains were flushed with tap water. Control replicates were treated the same way but with water instead of the powdered drain treatments. Contents of the buckets into which the drain apparatus drained were poured through sieves to collect and count the larvae flushed from their substrate in the drain assemblies. The two different formulas were efficacious at flushing drain fly larvae from a drain assemblies: with formulation 1 flushing 95.0% of larvae and formulation 2 flushing 100% of larvae.

### Test System

Identity: Drain Flies (Clogmia albipunctata) (A.K.A. Sewer flies, Sewer gnats, Filter flies, Sink flies, Moth flies)
Strain: N/A
Age: Larvae
Sex: Unsexed
Resistance: Non-resistant

### Test Substances:

Formulations 1 and 2 from Table 3.

### Control Substance

8 fluid oz. of water was used as a control substance.

### Dosing

Measured doses of 55 g of powder were weighed for each replicate. Exact weights were recorded.

### Pre-Treatment Rearing Condition

When applicable, test systems were provided with adequate food, water and harborage under controlled temperature and humidity conditions.

### Control of Bias

A population of only healthy vigorous test systems was selected for this study. Test systems with aberrant behavior of appearing unhealthy were avoided.

### Justification for Selection of Test System

Drain flies are targeted insects on the label of the test substances. They are an important pest insect throughout the United States and other parts of the world. They are readily and reliably reared in a laboratory setting, which allows testing to be performed under controlled and reproducible conditions.

### Materials

A. Test Substances as listed above in Test Substances
B. Test Systems, species listed above in Identification of the Test Systems
C. Test apparatus materials: Simulated washroom sink apparatus consisting of:
   1. Clear glass or plastic sink bowls
   2. Clear drain assembly, 1½″ diameter
   3. Clear p-trap, 1½″ diameter
   4. Clear waistline arm, 1½″ diameter
   5. Drain Elbow, 1½″ diameter
   6. Cotton clothesline substrate (conditioned/aged in nutrient water
   7. Laboratory stands with clamp arms to hold sink/drain apparatus upright.
D. 1 & 3-gallon plastic buckets to hold flushing water and catch flushed water and treatments
E. Soft forceps for transferring test systems
F. Stopwatches/countdown timers
G. Data sheets
H. Permanent Pen
I. Tape and Marker for labeling
J. Graduated beakers to measure volumes of water and nutrient water
K. A calibrated balance which weighs within 0.01 g. The appropriate SOP for the balance will be followed. The balance identification number will be documented in the raw data
L. Weight set for checking the calibration of the balance
M. Plastic transfer cups such as 002C from Pioneer plastics
N. Plastic rearing cups such as 115b from Pioneer plastics
O. 30-mesh and 60-mesh sieves
P. Tap water
Q. Graduated beaker/measuring cup
R. Funnel

### Method

### A. Test Design:

1. Five replicates were run for each test substance and controls.
2. Each replicate contained 10 test systems.
3. Final counts same days as treatment.

### B. Preparation:

1. Lengths of approximately 18″ long cotton rope were “conditioned” by soaking them for several days to a week in nutrient water.
2. Built a sink/drain apparatus for each test and control replicate.
3. A length of conditioned cotton clothesline substrate was “snaked” through each drain apparatus so that the drain fly larvae have something to crawl on, as the larvae are not truly
100% aquatic, and need something to cling to and walk along to prevent drowning/exhaustion. Growth on the rope from its conditioning is also a source of food for the larvae.
4. Test system set-up took place the day before test substance application.
   a. Test system set-up took place the day before test substance application.
   b. Emptied rearing cup contents into a 30-mesh sieve over a 60-mesh sieve.
   c. Rinsed cup with cool water to get all contents out.
   d. Rinsed larvae from mesh back into the clean larval cup or similar with clean shallow water (˜1″ deep)
   e. Transported test systems to testing area.
   f. When healthy wriggling larvae were seen, gently picked them up with soft forceps and placed them into a small transfer cup with cool/room temp tap water.
   g. Selected 10 larvae for the transfer cup.
   h. Using a turkey baster, gently transferred the test systems from the transfer cup to a sink/drain arena replicate.
   i. flushed with a bit of extra water if larvae get stuck alongside the pipe wall or on the rope above the p-trap water level.
   j. Repeated until all sink/drain arenas replicates have received their test systems.
   k. Allowed the test systems to acclimate overnight.

### C. Test Procedure:

1. Measure 55 g of test substance powder into a cup and recorded the actual weight.
2. Place funnel in drain opening of sink.
3. Pour measured test substance powder through the funnel into the drain.
4. For Control replicates, add 8 oz of cool/room temperature tap water instead of measured powder.
5. Immediately after adding powder (or control water), start countdown timer set for 1-hour.
6. At the 5-minute mark, add 4 oz of cool or room temperature tap water.
7. After adding the 4 oz of water to a replicate, start the next replicate.
8. Repeat until all test replicates have been treated.
9. When the 1 hr timer finishes, pour approximately 1-gallon of cool/room temperature water into the sink/drain apparatus.
10. Pour contents of flush bucket through a 30-mesh sieve over a 60-mesh sieve.
11. Count larvae found and record data on data sheet.
12. Pour contents of p-trap through sieves, search for any larvae still clinging to cotton rope.
13. Count larvae found in p-trap and rope and record data on data sheet.
14. Following the final counts, disposed of test insects with scalding hot water and a garbage disposal.
15. Test apparatus washed by hand with a dish soap and scrub brushes.

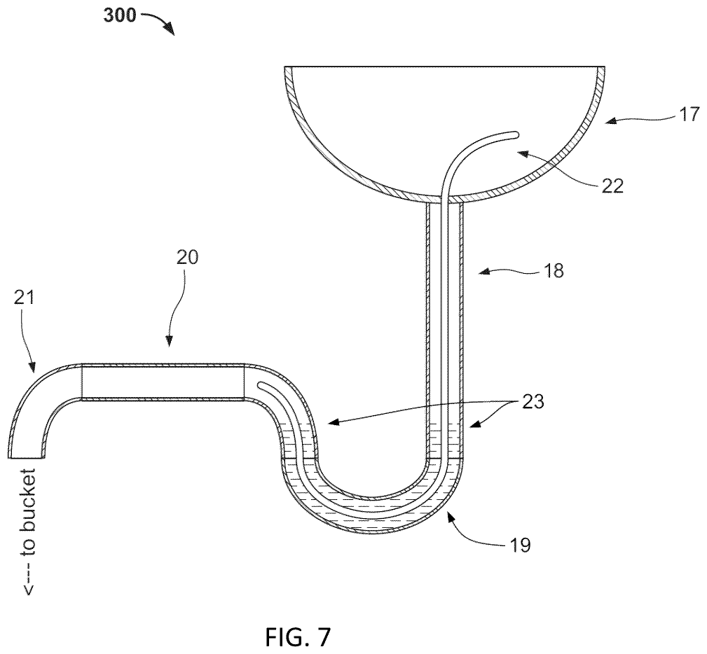

A diagram of the test apparatus (300) is shown in FIG. 7 with water level (23) indicated, which includes a sink (17), a drain assembly (18), a p trap (19), a drain wasteline arm (20), and a drain elbow (21) that drains into a bucket. The apparatus further includes a cotton rope (22).

### Data Calculations & Transformations

Mean & median percentages of larvae flushed were determined for test substances and untreated control using Microsoft Excel. Abbot's formula, normally used to account for control mortality, was applied in this flushing test to compensate for control numbers flushed from water control replicates. Abbot's formula was calculated in Excel.

Abbott's formula: 1−((1−(% Test flushing))/(1−(% Control flushing))). Percent flushed expressed as decimals within formula.

### Results and Discussion

Table 7 shows the mean amounts of test substances used, median, and mean percentages flushed.

TABLE 7
Efficacy against drain flies (Clogmia albipumctata)

| | Mean Grams | Median | Corrected |
|---|---|---|---|
| | of Test | Percentage | Flush |
| Treatment | Substance | Flushed | Percentage |
| Water Control | n/a (8 oz water) | 54.5% | 60.0%* |
| Formulation 1 | 55.003 | 100.0% | 100.0% |
| Formulation 2 | 55.001 | 100.0% | 95.0% |

Mean flushing percentages for test substances corrected with Abbott's formula
*No correction needed for control

The test results demonstrate that both formulations tested showed efficacy in flushing drain fly larvae from the p-traps when used as directed. There was a fair amount of flushing in the control replicates, with 60% of larvae on average being flushed out, demonstrating that while regular sink usage does result in flushing, flushing with water alone is not enough to control drain fly larvae in drains.

Both powder formulations have the same median flushing percentages of 100%, which indicates their similar efficacy. The corrected mean percentages of flushing, 100% for formulation 1, and 95.0% for formulation 2, supports the claim that both formulations tested flush drain fly larvae from sink drains when used as directed.

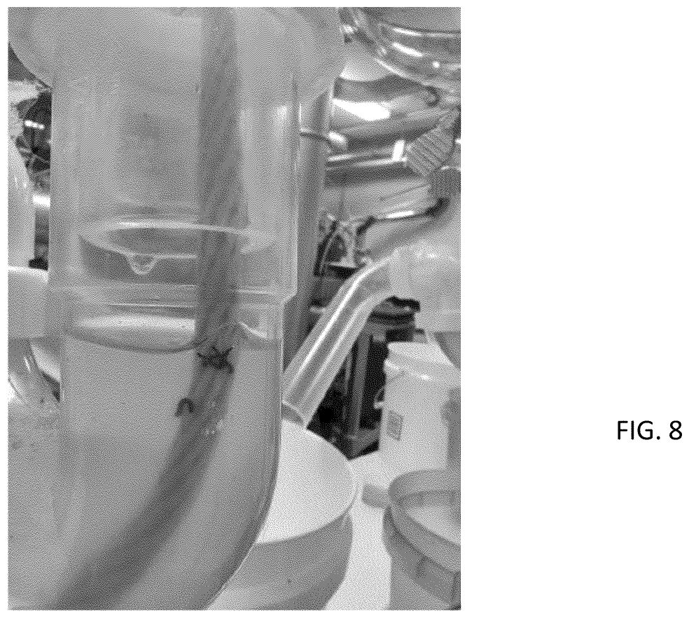

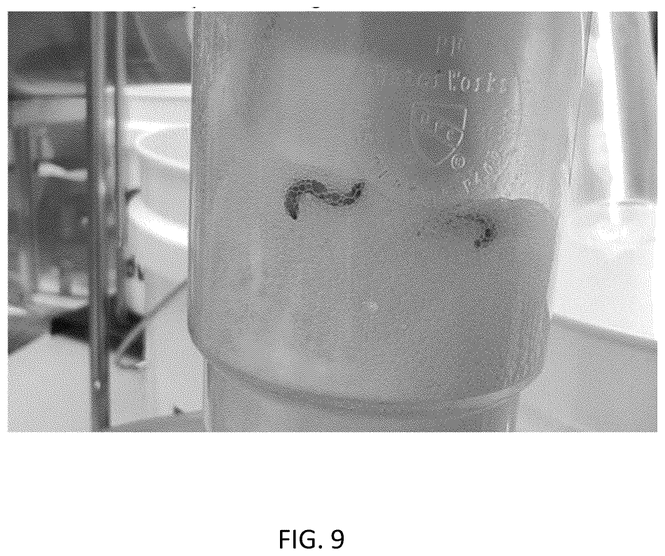

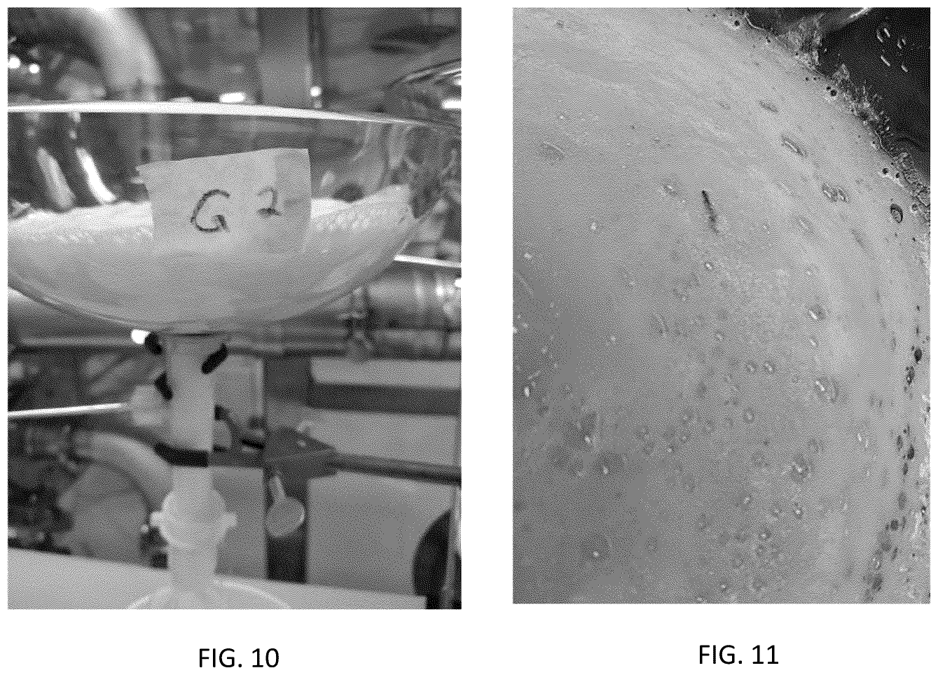

FIGS. 8-11 show some of the experiment photos.

### Environmental Conditions

Study was conducted in a laboratory held at a temperature of 80±2° F. (27±1° C.), and relative humidity of 50%±20; and artificial lighting on timers set for 14 hrs on, 10 hrs off.

### Proposed Label Instructions/Directions for Use

1. Remove sink or drain strainer if present.
2. Run water through drain for 30 seconds prior to treatment.
3. Tear open top of one pouch and pour entire contents into the drain.
4. Run water for 3 seconds to ensure foaming, let rest for one hour, then rinse with water.
5. Wash hands after handling. Repeat weekly until problem is resolved. Do not use more than once per day.

### Study 4: Flushing Efficacy of Test Formulations Against Fruit Fly Larvae in Simulated Sink Drains in a Laboratory.

### Purpose

Provide flushing efficacy data for foaming test formulations against fruit fly larvae in a sink drain in a laboratory environment.

### Overview

Fruit fly larvae in sink and drain assemblies were exposed to powdered test formulations and tap water in a manner consistent with proposed label use instructions. At the end of the treatment exposure period, drains were flushed with tap water. Control replicates were treated the same way but water instead of the powdered drain treatments. Contents of the buckets into which the drain apparatus drained, and the contents of the p-traps were poured through sieves to collect and count the larvae flushed from their substrates in the drain assemblies above the p-traps. The two different formulas tested were efficacious at flushing fruit fly larvae: with formulation 1 flushing 71.0% of larvae and formulation 2 flushing 80.0% of larvae.

### Test System

Identity: Fruit flies (Drosophila hydei) (A.K.A. Vinegar flies)
Strain: N/A
Age: Larvae
Sex: Unsexed
Resistance: Non-resistant

### Test Substances:

Formulations 1 and 2 from Table 3.

### Control Substance

4 fluid oz. of water was used as a control substance. The same volume of activation and flush water was also added to the control replicates as was used in the test replicates.

### Dosing

Measured doses of 55 g of powder were weighed for each replicate. Exact weights were recorded.

### Pre-Treatment Rearing Condition

When applicable, test systems were provided with adequate food, water and harborage under controlled temperature and humidity conditions.

### Control of Bias

A population of only healthy vigorous test systems was selected for this study. Test systems with aberrant behavior of appearing unhealthy were avoided.

### Justification for Selection of Test System

Fruit flies are targeted insects on the label of the test substances. They are an important pest insect throughout the United States and globally. They are readily and reliably reared in a laboratory setting, which allows testing to be performed under controlled and reproducible conditions.

### Materials

A. Test Substances as listed above in Test Substances
B. Test Systems, 20 per replicate, species listed above in Identification of the Test Systems
C. Test apparatus materials: Simulated washroom sink apparatus consisting of:
   a. Clear glass or plastic sink bowls
   b. Clear drain assembly, 1½″ diameter
   c. Extra Drain extension tube 1½″ dia., 6″ long
   d. Clear p-trap, 1½″ diameter
   e. Clear Drain waistline arm, 1½″ diameter
   f. 90° elbow, 1½″ diameter
   g. Laboratory stands with clamp arms to hold sink/drain apparatus upright.
D. 1 & 3-gallon plastic buckets to hold flushing water and catch flushed water and treatments
E. Soft forceps for transferring test systems
F. Stopwatches/countdown timers
G. Data sheets
H. Permanent Pen
I. Tape and Marker for labeling
J. Graduated beakers to measure volumes of water and nutrient water
K. A calibrated balance which weighs within 0.01 g. The appropriate SOP for the balance will be followed. The balance identification number will be documented in the raw data
L. Weight set for checking the calibration of the balance
M. Plastic transfer cups such as 002C from Pioneer plastics
N. Plastic rearing cups such as 115b from Pioneer plastics
O. 30-mesh and 60-mesh sieves
P. Tap water
Q. Graduated beaker/measuring cup
R. Funnel
S. Microwave
T. Plastic tube approximately 1″ outside diameter
U. Metal rod approximately ½″ diameter
V. Fruit fly media (Hydei formula from Josh's Frogs)
W. Metal spatula

### Method

### A. Test Design:

1. Five replicates were run for each test substance and controls
2. Each replicate contained 20 test systems.
3. Final readings were completed on same day as treatment.

### B. Preparation:

1. Built a sink/drain apparatus for each test and control replicate.
2. Test system set-up took place the day before test substance application.
   a. Test systems were set up inside the extra drain extension tubes which were placed between the p-trap and sink drain assembly.
   b. The inside walls of the extra extension tube were completely coated/spackled fruit fly larval media from the bottom of the tube to 2″ from the top threads for an effective length of 4″ of coated tube. This replicated the wall build up that would occur in a home sink, and where the fruit fly larvae would normally develop.
      1. Measured 75 mL of filtered water
      2. Boiled water in microwave
      3. Added 50 mL of powdered fruit fly media mix
      4. Stirred with metal spatula
      5. Pushed drain extension tube onto the hot pliable media to compact the media up into the entirety of the extension tube.
      6. Once tube was filled, used long 1″ diameter hollow plastic tube to cut out a hole from the inside length of the media packed extension tube.
      7. Used metal rod to push the media out of the hollow plastic tube for next use.
      8. Used metal spatula to trim media from inside areas of the drain extension tube above the intended 4″ length.
      9. Used metal spatula to spackle in leftover media to any spots along the wall that needed repairing.
      10. Allowed media to cool (by time finished adding media to tubes, first completed tubes were cooled).
   c. Added fruit fly larvae
      1. Pulled excelsior wood wool from fruit fly culture.
      2. Dipped excelsior into shallow water in a plastic dish to dislodge larvae.
      3. Used soft forceps to select and transfer larvae from water into the media-spackled extension tubes.
      4. Once 20 larvae were counted into a tube, each end was sealed with parafilm.
   d. Larvae were allowed to acclimate overnight with tubes resting on their sides.
3. The next day, parafilm was removed and larvae were inspected for health.
4. Once a tube was deemed acceptable, p-traps were filled and extension tubes with media and fruit fly larvae were assembled into the laboratory sink assemblies.

### C. Test Procedure:

1. Measure 55 g of test substance powder into a cup and recorded the actual weight.
2. Place funnel in drain opening of sink.
3. Pour measured test substance powder through the funnel into the drain.
4. For Control replicates, add 4 oz of cool/room temperature tap water instead of measured powder.
5. Immediately after adding powder (or control water), start countdown timer set for 1-hour.
6. At the 5-minute mark, add 4 oz of cool or room temperature tap water.
7. After adding the 4 oz of water to a replicate, start the next replicate.
8. Repeat until all test replicates have been treated.
9. When the 1 hr timer finishes, pour approximately 2 liters of cool/room temperature water into the sink/drain apparatus.
10. Pour contents of flush bucket and p-trap through a 30-mesh sieve over a 60-mesh sieve.
11. Count larvae found and record data on data sheet.
12. Following the final counts, disposed of test insects with scalding hot water and a garbage disposal.
13. Test apparatus was washed by hand with a dish soap and scrub brushes.

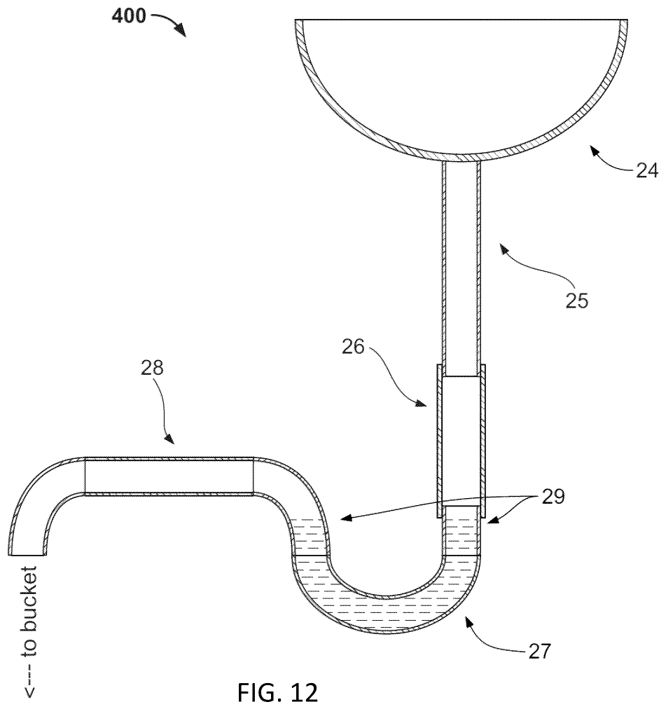

A diagram of the test apparatus (400) is shown in FIG. 12 with water level (29) indicated, which includes a sink (24), a clear drain assembly (25), an opaque extra drain tube extension (26) with larval media along interior walls, a clear p trap (27), and a drain wasteline arm (28) that drains into a bucket.

### Data Calculations & Transformations

Mean & median percentages of larvae flushed were determined for test substances and untreated control using Microsoft Excel. Abbot's formula, normally used to account for control mortality, was applied in this flushing test to compensate for control numbers flushed from water control replicates. Abbot's formula was also calculated in Excell.

Abbott's formula: 1−((1−(% Test flushing))/(1−(% Control flushing))). Percent flushed expressed as decimals within formula.

### Results and Discussion

Table 8 shows mean gram amount of the test substances used in testing, median and mean percents flushed from control and test replicates.

TABLE 8
Efficacy against fruit flies (Drosophila hydei)

| | | | Corrected |
|---|---|---|---|
| | Mean Grams | Median | Mean |
| | of Test | Percentage | Flush |
| Treatment | Substance | Flushed | Percentage |
| Water Control | n/a (4 oz water) | 10.0% | 14.0%* |
| Formulation 1 | 55.001 | 75.0% | 71.0% |
| Formulation 2 | 55.002 | 75.0% | 80.0% |

Mean flushing percentages for test substances corrected with Abbott's formula
*No correction needed for control

The test results demonstrate that both formulations tested showed efficacy in flushing fruit fly larvae from the drain assemblies when used as directed. There was some flushing in the water control replicates, but with only 14.0% of larvae flushed it is certain that water alone is not enough to control fruit fly larvae in drains.

Both powder formulations have the same median flushing percentages of 75%, which indicates their similar efficacy. The corrected mean percentages of flushing, 71.0% for formulation 1, and 80.0% for formulation 2, supports the claim that both formulations tested flush fruit fly larvae from sink drains when used as directed, especially if used weekly as directed in step 5 of the usage instructions.

### Environmental Conditions

Study was conducted in a laboratory held at a temperature of 72±3° F. (27±1° C.), and relative humidity of 50%±20%; and artificial lighting on timers set for 14 hrs on, 10 hrs off.

### Proposed Label Instructions/Directions for Use

1. Remove sink or drain strainer if present.
2. Run water through drain for 30 seconds prior to treatment.
3. Tear open top of one pouch and pour entire contents into the drain.
4. Run water for 3 seconds to ensure foaming, let rest for one hour, then rinse with water.
5. Wash hands after handling. Repeat weekly until problem is resolved. Do not use more than once per day.

### Example 3

Various formulations were tested to study the foam volume/height generated. Table 9 shows a range of formulas tested, varying the ratio of foaming agents by weight.

TABLE 9

| | | Adjusting Sodium Bicarbonate:Citric | | | | | |
|---|---|---|---|---|---|---|---|
| Ingredient | Function | Acid Ratio | | | | | |
| Citric Acid, Anhydrous USP | Foaming (Acid) | 46.5 | 42 | 38.5 | 35.5 | 33 | 31 |
| Sipernat 50S (Silica) | Anti-Caking | 4 | 4 | 4 | 4 | 4 | 4 |
| | Agent | | | | | | |
| Sodium Bicarbonate | Foaming (Base) | 46.5 | 51 | 54.5 | 57.5 | 60 | 62 |
| Lemongrass Oil | Active | 0.5 | 0.5 | 0.5 | 0.5 | 0.5 | 0.5 |
| | Ingredient | | | | | | |
| Sodium Lauryl Sulfate | Surfactant | 2.5 | 2.5 | 2.5 | 2.5 | 2.5 | 2.5 |
| (95% purity) | | | | | | | |
| Corn Starch | Filler | 0 | 0 | 0 | 0 | 0 | 0 |

| % Bicarb./% Citric. | | | | | |
|---|---|---|---|---|---|
| 1.00 | 1.21 | 1.42 | 1.62 | 1.82 | 2.00 |

Additionally, while holding foaming agent ratio constant, formulas with a range of % surfactant (by weight) were tested, as shown in Table 10:

TABLE 10

| Ingredient | Function | Adjusting % Surfactant | | | | | |
|---|---|---|---|---|---|---|---|
| Citric Acid, Anhydrous USP | Foaming (Acid) | 38 | 37.7 | 37.4 | 37 | 36.6 | 36.2 |
| Sipernat 50S (Silica) | Anti-Caking | 4 | 4 | 4 | 4 | 4 | 4 |
| | Agent | | | | | | |
| Sodium Bicarbonate | Foaming (Base) | 57 | 56.55 | 56.1 | 55.5 | 54.9 | 54.3 |
| Lemongrass Oil | Active | 0.5 | 0.5 | 0.5 | 0.5 | 0.5 | 0.5 |
| | Ingredient | | | | | | |
| Sodium Lauryl Sulfate | Surfactant | 0.5 | 1.25 | 2 | 3 | 4 | 5 |
| (95% purity) | | | | | | | |
| Corn Starch | Filler | 0 | 0 | 0 | 0 | 0 | 0 |

| % Surfactant | | | | | |
|---|---|---|---|---|---|
| 0.5 | 1.25 | 2 | 3 | 4 | 5 |

Similarly, at a fixed ratio of foaming agents (and all other formula ingredients), a range of total % foaming agents (by weight) were tested, as shown in Table 11:

TABLE 11

| Ingredient | Function | Adjusting % Foaming Agent | | | | | |
|---|---|---|---|---|---|---|---|
| Citric Acid, Anhydrous USP | Foaming (Acid) | 24 | 26.76 | 29.52 | 32.28 | 35.04 | 37.8 |
| Sipernat 50S (Silica) | Anti-Caking | 4 | 4 | 4 | 4 | 4 | 4 |
| | Agent | | | | | | |
| Sodium Bicarbonate | Foaming (Base) | 36 | 40.14 | 44.28 | 48.42 | 52.56 | 56.7 |
| Lemongrass Oil | Active | 0.5 | 0.5 | 0.5 | 0.5 | 0.5 | 0.5 |
| | Ingredient | | | | | | |
| Sodium Lauryl Sulfate | Surfactant | 1 | 1 | 1 | 1 | 1 | 1 |
| (95% purity) | | | | | | | |
| Corn Starch | Filler | 34.5 | 27.6 | 20.7 | 13.8 | 6.9 | 0 |

| % Foaming Agent | | | | | |
|---|---|---|---|---|---|
| 60 | 66.9 | 73.8 | 80.7 | 87.6 | 94.5 |

### Method

Measurements of the total height of the foam reached were conducted in a graduated cylinder. For these runs, the volume of foam reached in a typical pipe size was approximated by setting Volume=pi*(pipe radius)²*(pipe height reached), and solving for height.

### Apparatus and Reagents

Balance
2 L Thermo Scientific™ Nalgene™ PMP Plastic Graduated Cylinders
50 mL disposable polypropylene beaker
Scoopula
Thermometer

### Test Specimens and Conditioning

The test should be conducted using 20° C. (+/−0.1° C.) purified water. The test should be conducted at ambient conditions. The powder should be at ambient conditions.

### Procedure

Fill a 2 L plastic graduated cylinder with 500.00 g+/−10 g of 20° C. (+/−0.1° C.) purified water.
Weigh out 15.00 g+/−0.05 g of powder intermediate into 50 mL disposable polypropylene beaker using a scoopula, record weight.
Pour the powder directly down into the graduated cylinder by quickly inverting the 50 mL disposable beaker of powder intermediate above the center of the graduated cylinder. Avoid getting powder on walls of graduated cylinder.
Record the maximum foam height in mL when the foam reaches the highest volume in the graduated cylinder.

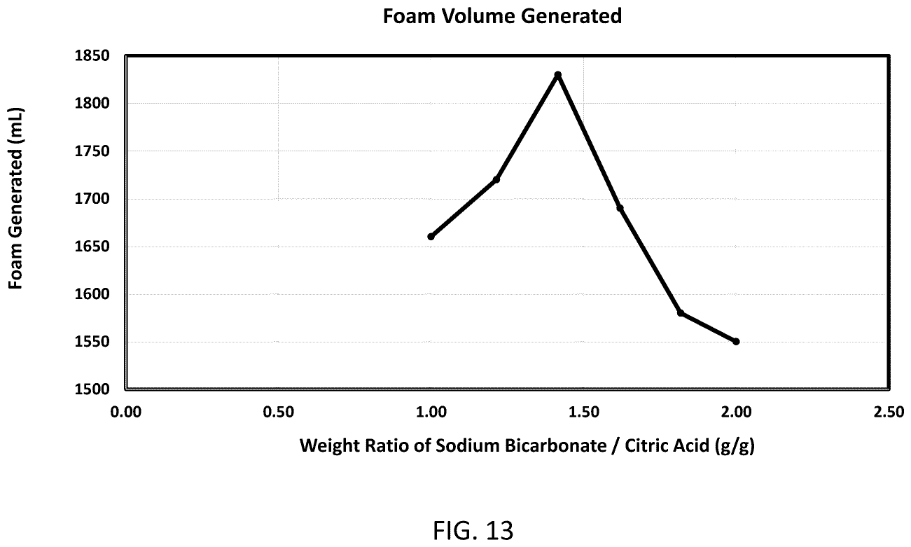

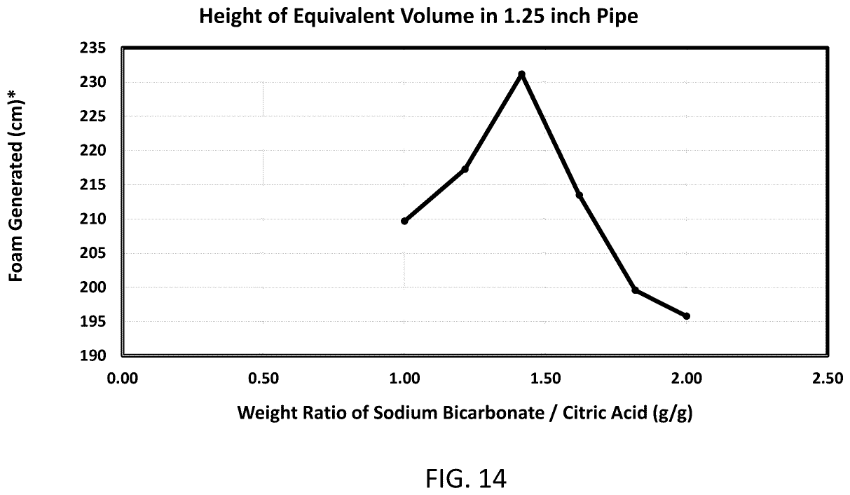

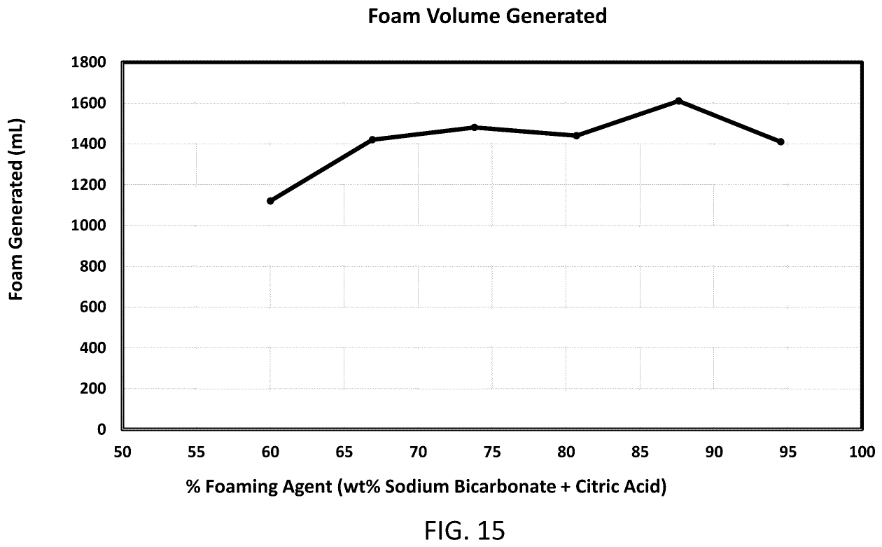

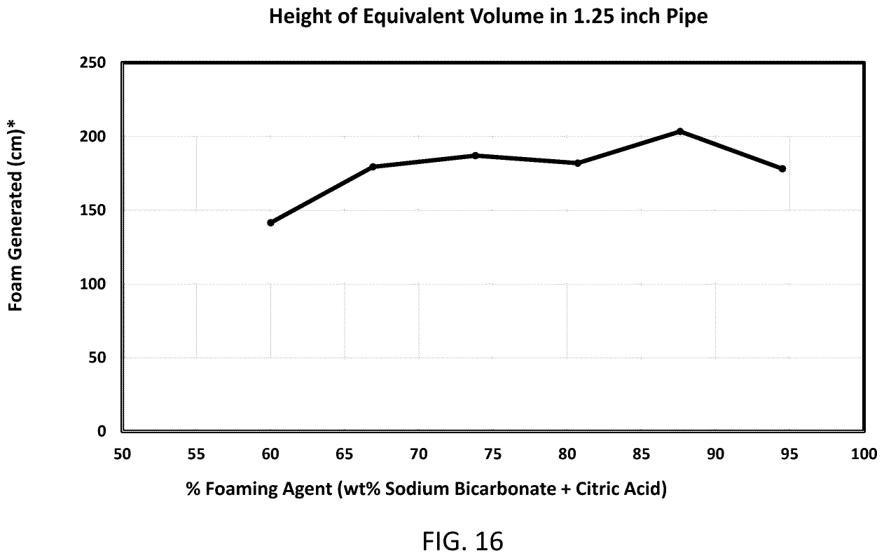

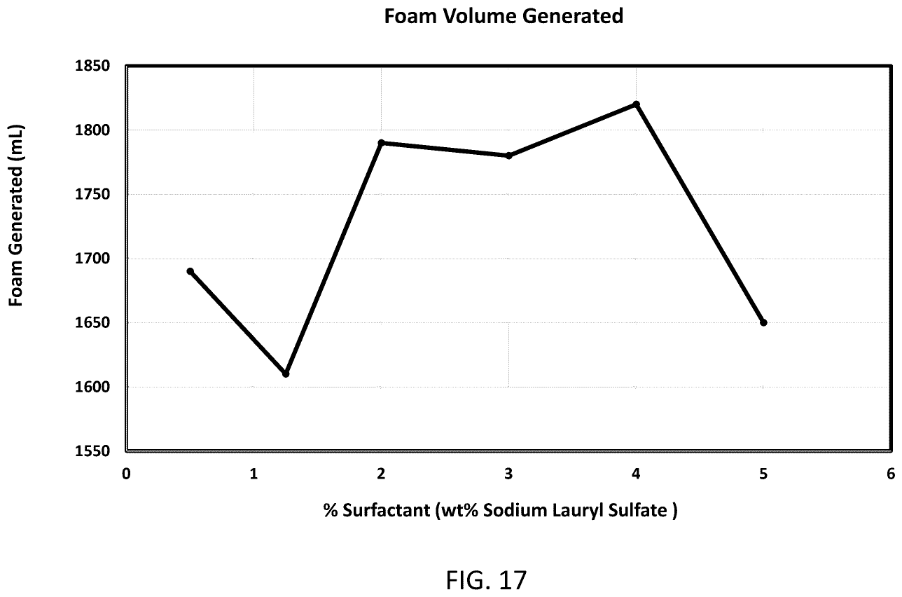

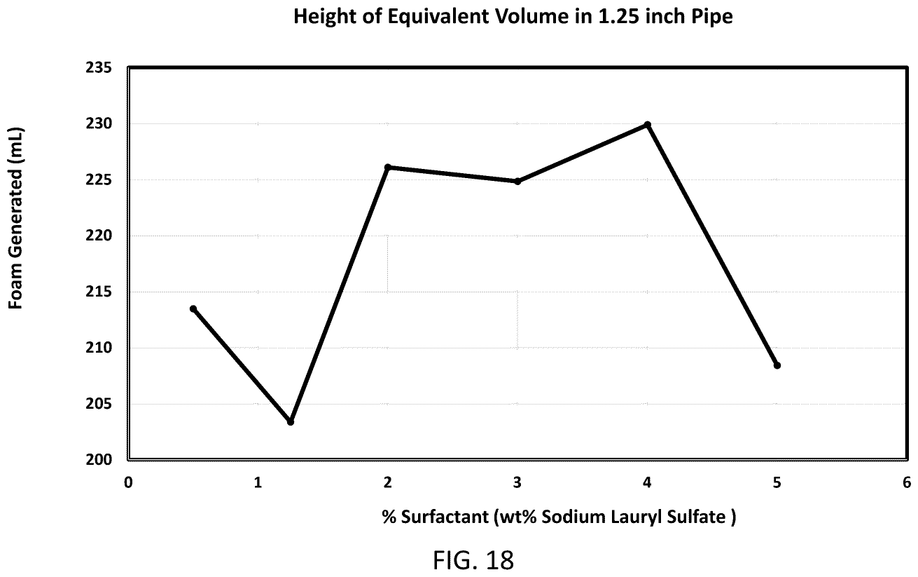

The results of the studies are shown in FIGS. 13-18. Specifically, FIGS. 13-14 show foam volume and height of equivalent volume generated with varying ratios of foaming agents. FIGS. 15-16 show foam volume and height of equivalent volume generated with varying amounts of the total foaming agents. FIGS. 17-18 show foam volume and height of equivalent volume generated with varying levels of the surfactant.

### CONCLUSION

$${V}_{c y l i n d e r} = {V}_{p i p e} = π {r}^{2} h$$

Where V=volume, r=radius, h=height. Assuming equal volume of foam generation, but different pipe radius:

$${V}_{pipe 1} = {V}_{pipe 2} = π * {r}_{1}^{2} * {h}_{1} = π * {r}_{2}^{2} * {h}_{2}$$

Having measured volume in one cylinder (pipe), one can take that measured value and solve for equivalent height in other pipe (in this case a more typical household pipe of diameter 1.25 inches):

$${V}_{measured} = π * {r}_{2}^{2} * {h}_{household pipe} \\ {h}_{h o u s e hold pipe} ( cm ) = \frac{{V}_{m e a s u r e d} ( mL )}{π * {( \frac{3.175 cm}{2} )}^{2}}$$

### Example 4

Various formulations were tested to study the cling time of the foam generated from the test formulation. Table 9 shows a range of formulas tested, varying the ratio of foaming agents.

### Method

### Gravimetric Foam Cling Method:

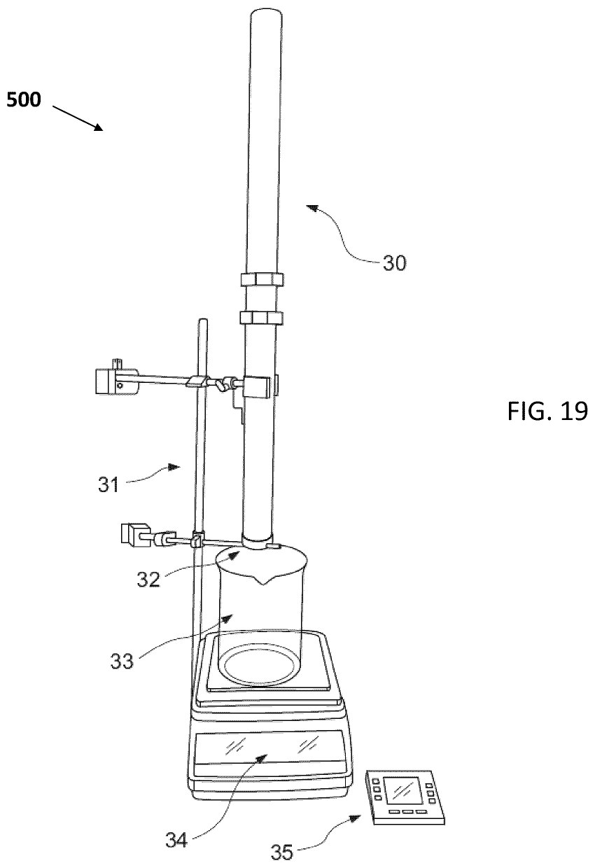

1. A test apparatus (500) is shown in FIG. 19. A 25-inch length of pipe (30) is affixed vertically to a ring stand (31). The bottom end of the pipe is capped with a silicone plug (32). A beaker (33) is positioned beneath the apparatus (below the plug) to collect runoff.
2. A scale (34) is placed below the beaker and tared. A stopwatch (35) is placed next to the scale display.
3. Affix a camera (not shown in FIG. 19) to ring stand positioned with a view of the scale reading and stopwatch.
4. The plug at the bottom of the pipe is weighed and recorded before starting a trial.
5. 100 g of deionized water at room temperature is added the apparatus. Record precise amount of water added.
6. A 5 g sample of formula is measured out and poured quickly into the test apparatus via funnel. Record precise amount. While pouring powder into the apparatus, press start on the stopwatch.
7. Upon addition of formula, formula is allowed to foam up the apparatus pipe for 60 seconds. When that time expires, the silicone plug is removed and allowed to fall into the collection beaker, allowing water and foam to run off into the collection beaker and be weighed.
8. A significant portion of the original water in the apparatus will be converted to foam as the product reacts, so less than the original 100 g will drop when the plug is removed. Foam will gradually run out of pipe, and “total cling time” in this case will be defined as the time at which 97.8% of the total original mass added (mass of water+mass of formula powder) has run out of the pipe and into the collection vessel.

### Results

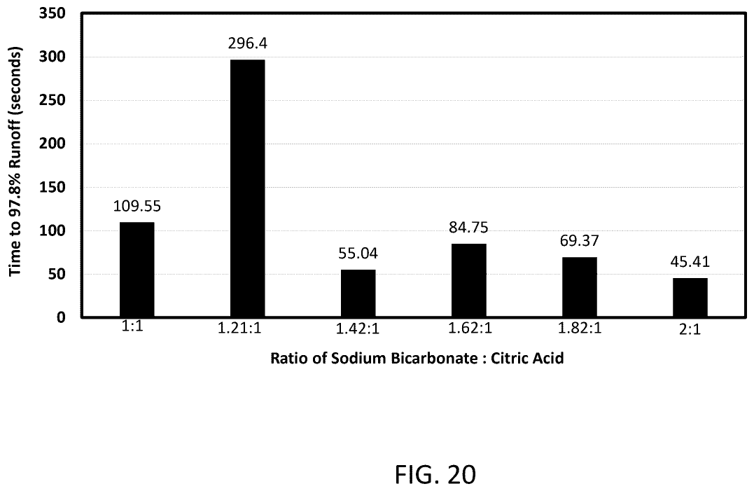

FIG. 20 shows the time at which 97.8% of the total original mass added (mass of water+mass of formula powder) has run out of the pipe and into the collection vessel (“Time to 97.8% Runoff”), for different formulations tested in Table 9.

### Example 5

In certain embodiments, a film may be formed after the foam and/or bubbles recede, or when the surfactant comes into contact with the insects, which covers the spiracles of the insects and leads to mortality through suffocation, achieving synergistic effects in insect control and/or repellency. Various formulations were tested herein to study the polarity of the film.

Table 10 shows a range of formulas tested, varying the range of % surfactant.

### Method

Formulas were prepared by diluting the sample into deionized water to form a 5% solution. A 10 uL droplet of the composition solution is deposited via precision pipette to a PVC substrate and the resulting static contact angle of the droplet on PVC is measured using the sessile drop technique taking a profile image via back illumination using a goniometer.

### Results

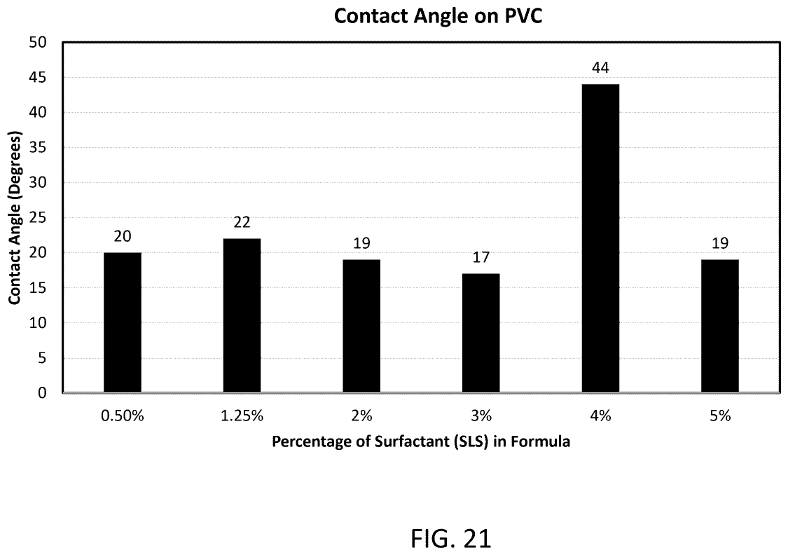

FIG. 21 shows the contact angles of sample solution droplets resting on a PVC substrate.

### Example 6

Various formulations were tested to study the volume of CO₂ generated. CO₂ is known to be an effective asphyxiant to “knockdown” or kill insects. Tables 9 and 11 show a range of formulas tested, varying the ratio of foaming agents (i.e., sodium bicarbonate and citric acid) and the total weight % of the foaming agents.

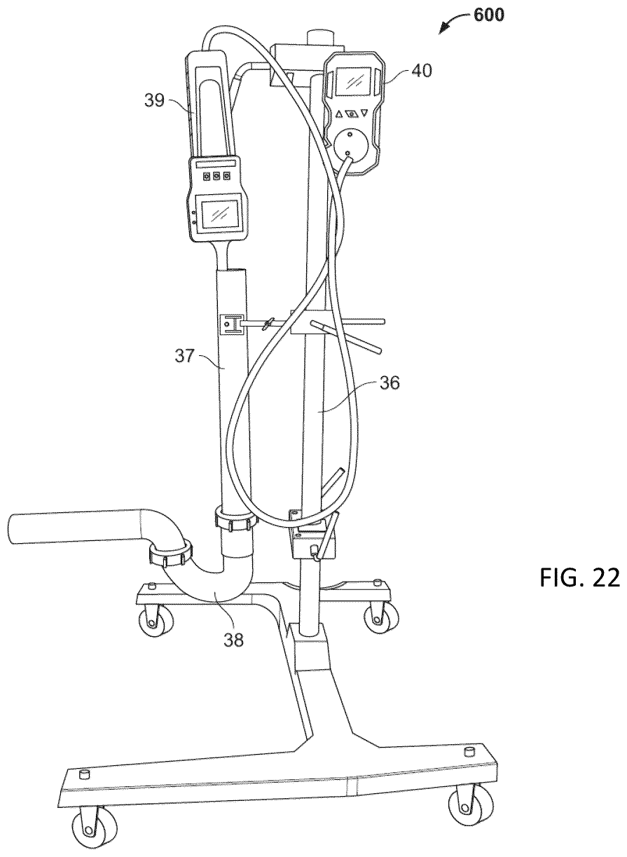

A test apparatus (600) is shown in FIG. 22, which includes a ring stand (36), a 12-inch drain tail piece (37), a p-trap (38), a gas sampling probe (39), and an oxygen meter (40).

### Method

1. Firmly affix drainpipe apparatus to ring stand such that top “drain” opening is vertical
2. On the same ring stand, mount an oxygen meter at least 6 inches above the drainpipe opening.
3. Connect the oxygen meter, with surgical tubing to a gas sampling probe. Activate the sampling probe, and record baseline ambient oxygen volume percentage level.
4. Fill the drainpipe apparatus with de-ionized water (approximately 350 mL)
5. Measure out 55.00+/−0.10 g of drain powder formula
6. Pour in formula in one quick motion.
7. Allow product to foam up and out of the drain for 5 minutes before sampling.
8. When that time is reached, activate the gas sampling probe and insert into drain. The stainless-steel probe should be fully immersed in the pipe, with the plastic “shoulder” piece resting on the pipe rim (as shown in FIG. 22).
9. Observe measurement displayed on the oxygen meter for 15-30 seconds and record the peak oxygen value observed.
10. Repeat at 5-10 minute increments for 60 minutes.
11. As CO₂ displaces oxygen, value on the meter will drop. The volume of CO₂ present in the drain can be calculated from this displacement at each reading.

Volume of the CO₂ generated is calculated using the equation below:

$$Volume \% {CO}_{2} = 1 - \frac{Volume \% {O}_{2} ( reading )}{Volume \% {O}_{2} ( baseline )}$$

### Results

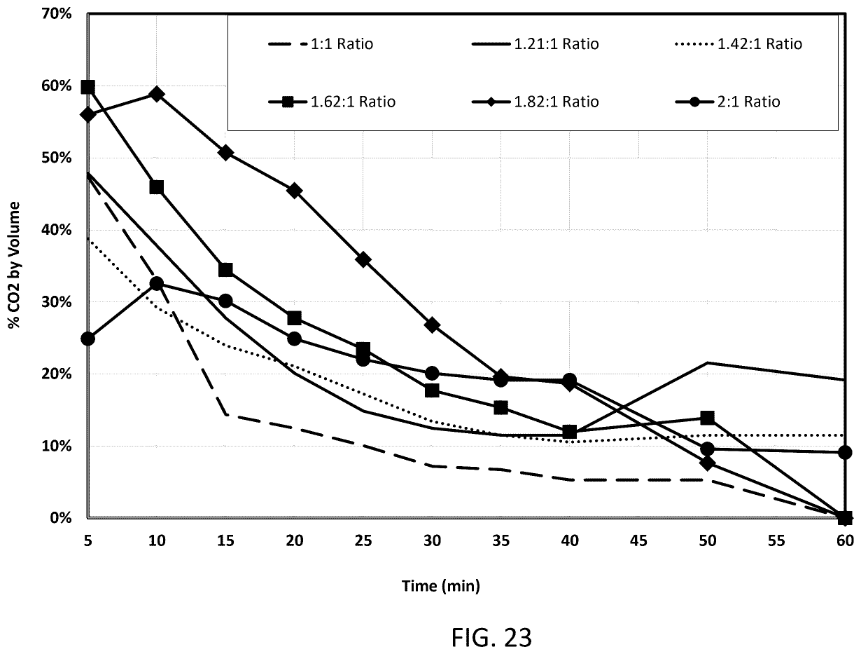

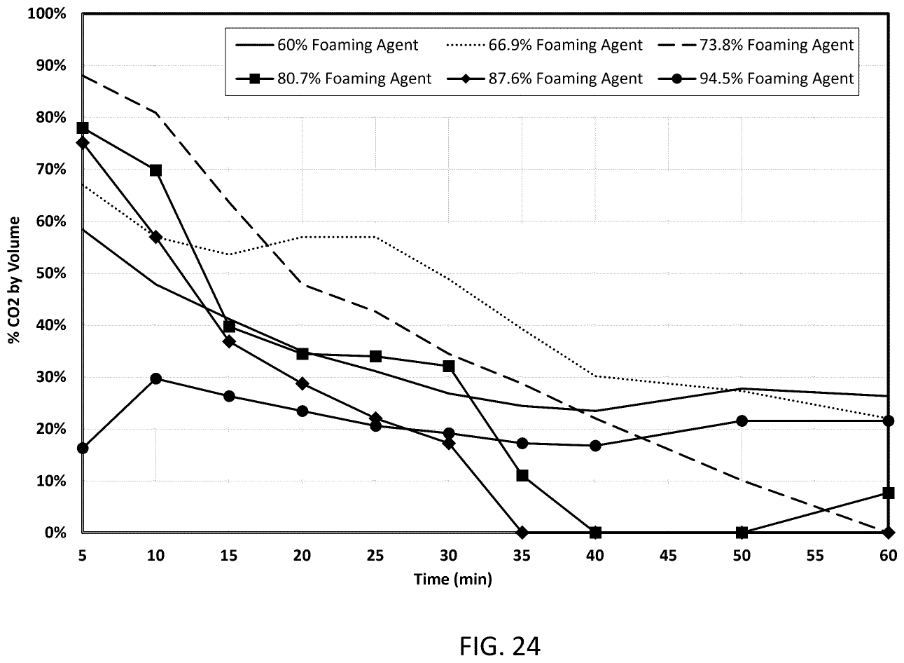

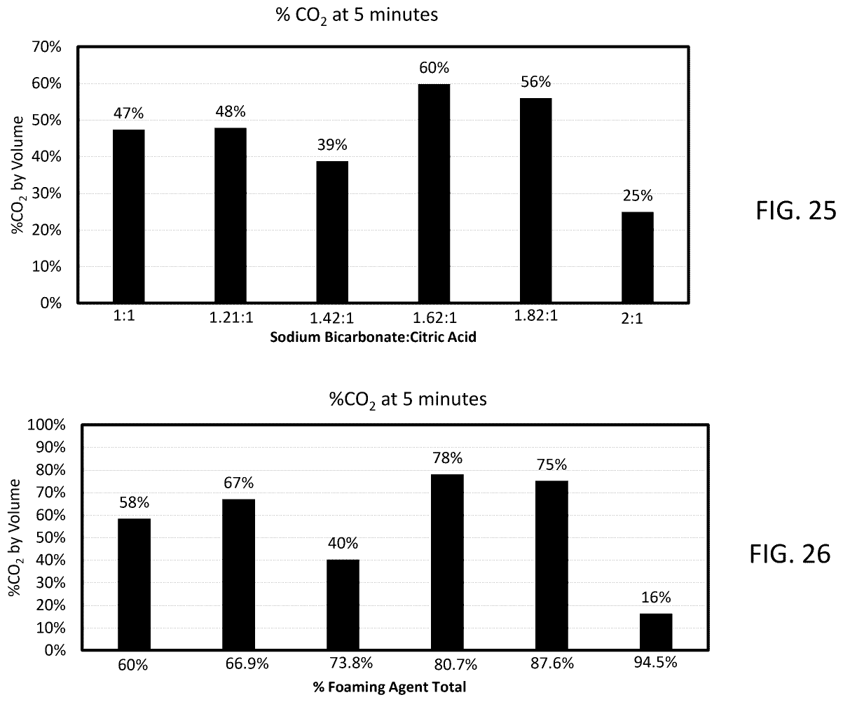

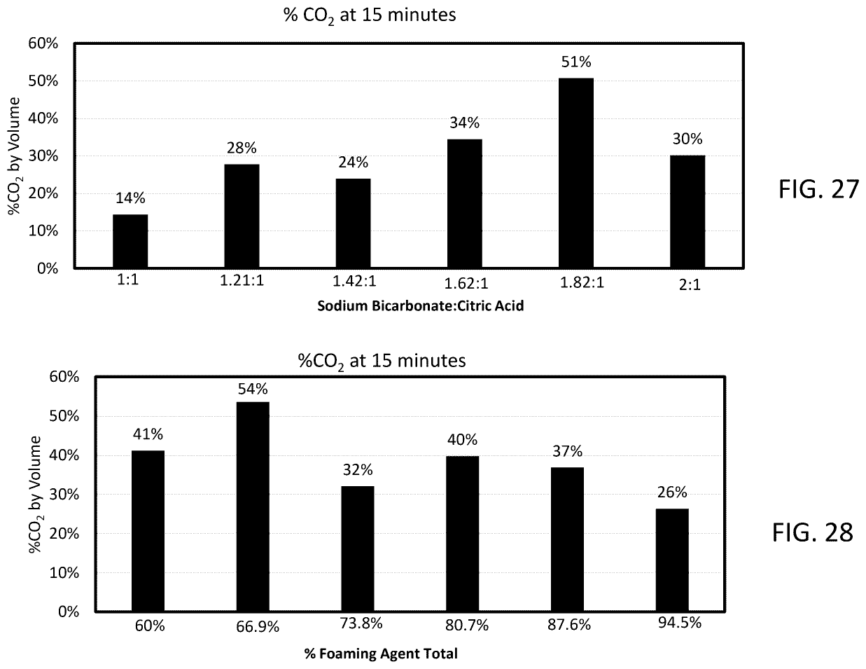

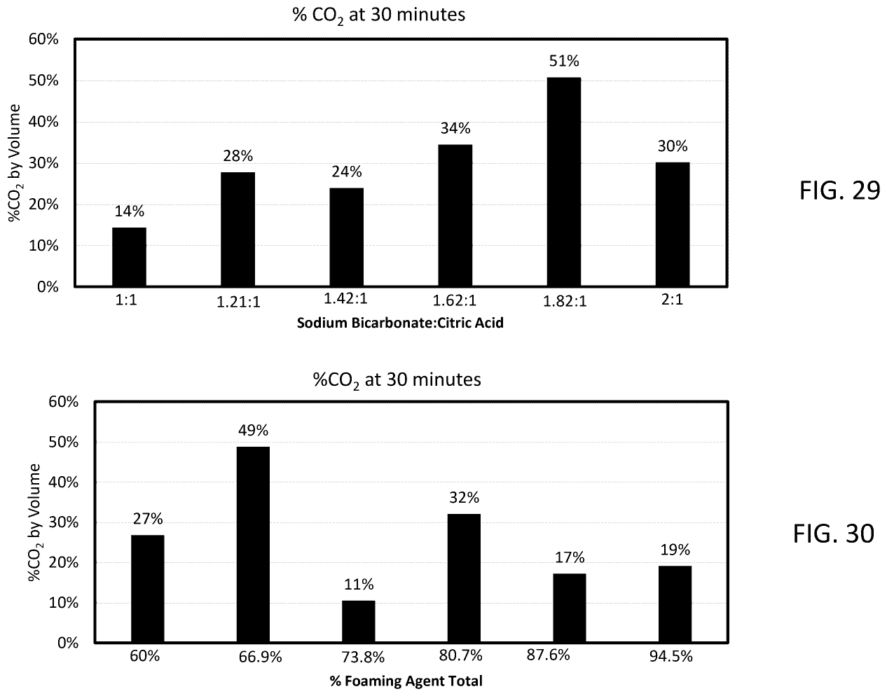

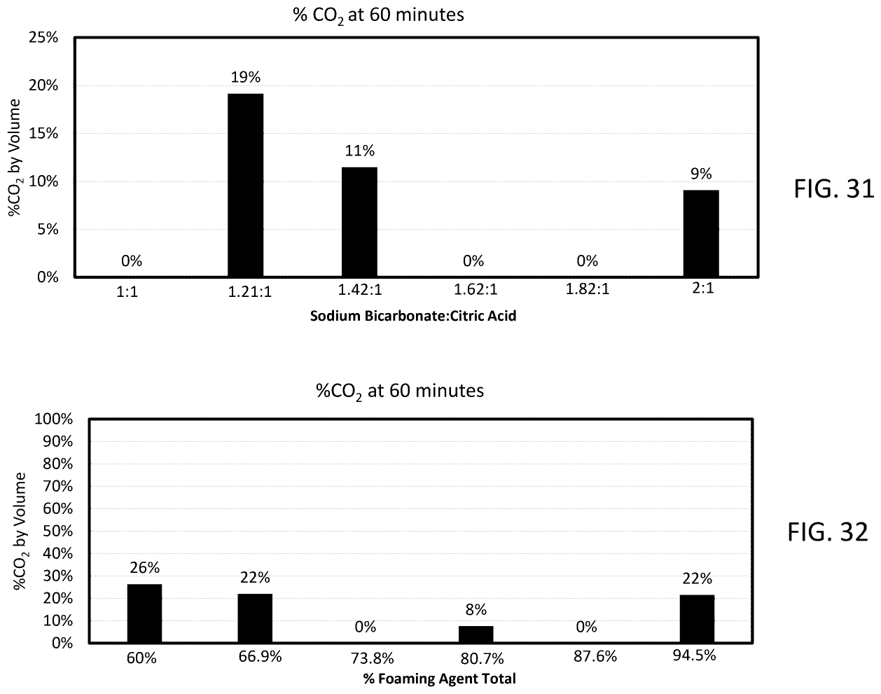

FIG. 23 shows the volume % CO₂ generated in the apparatus (pipe) over time for formulas with varying ratios of the foaming agents. FIG. 24 shows the volume % CO₂ generated in the apparatus (pipe) over time for formulas with varying levels of the foaming agents (by weight). FIGS. 25-32 show the volume % CO₂ generated in the apparatus (pipe) at 5 min, 15 min, 30 min, and 60 min from the formulas tested, with varying ratios of the foaming agents and varying levels of the foaming agents.

### Example 7

Various formulations were tested to study the size of the bubbles generated. Tables 9 and 10 show a range of formulas tested, varying the ratio of foaming agents (i.e., sodium bicarbonate and citric acid) and the total weight % of the surfactant (i.e., sodium lauryl sulfate).

### Method

This method was designed to assess the range of bubble size within a pipe upon introducing a reactive formula that generates CO₂ bubbles. For pest control applications, CO₂ bubbles can serve as an asphyxiant aiding in knockdown and kill of insects within a drainpipe. About 27.5 g of each formula was tested in the method described herein.

### Apparatus and Reagents

1000 mL graduated cylinder
Small beaker to hold formula
Small bucket to collect overflow during foaming
Ring stand
Camera (mobile phone)
Ruler

### Procedure

Place graduated cylinder in small bucket underneath ring stand.
Affix ruler at the level of the foam (2.5 cm above pipe) with ring stand. (Trial run may be necessary to determine the exact level of peak foaming).
Fill graduated cylinder with 175 mL of water.
Weigh out desired dose of formula into a small beaker (27.5 g).
Slowly pour formula into the graduated cylinder (10-20 second pour).
Formula will foam up (and potentially out of) graduated cylinder.
Take image at peak foaming (as soon as foam begins to recede).
Analyze image(s) using ImageJ software.
   Open bubble image in software.
   Set scale:
      Select straight line>make line along edge of ruler on centimeter side to a certain known length>select analyze>set scale>input the measured length in millimeters under “known distance”
   Take measurements of 20 seemingly largest bubbles:
      Select straight line>zoom in to bubble of interest>make a precise line showing the diameter of the bubble>analyze>measure
      To zoom in and out: magnifying glass>“+” and “−” keys
   Record 10 largest lengths from result window:
      Results>sort>length
      Delete top 10 shortest lengths
   Calculate mean of 10 largest diameters and standard deviations:
      Results>summarize
      Record mean
      Record standard deviation

### Calculations

Mean and standard deviation of the diameters of the 10 largest bubbles measured were calculated to determine the upper bound for bubble size range. Largest bubble size average will be used to establish the upper bound for bubble size range, with the lower bound being 0.

### Results

As bubble diameter decreases, bubbles become less and less detectable at a given camera resolution. As such, this method was designed to determine maximum bubble size produced in the foam. In validation, it was more reproducible to measure the 10 largest bubbles' diameters and average them.

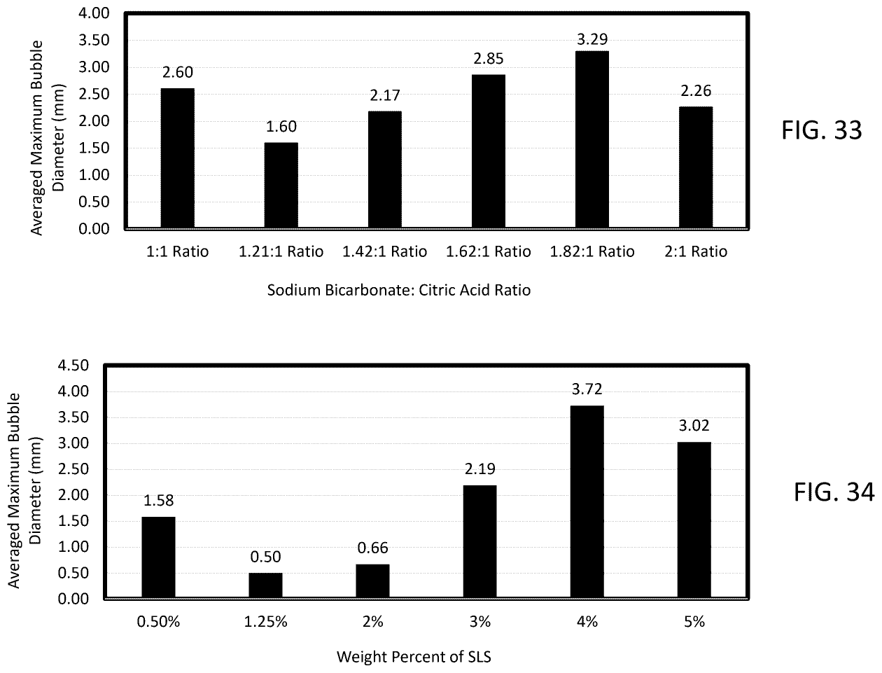

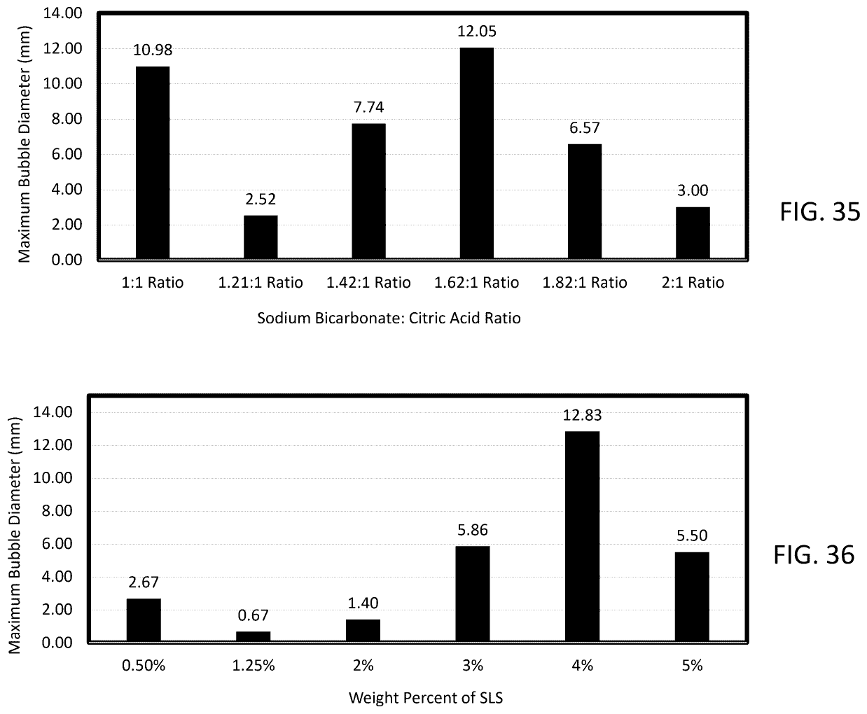

FIGS. 33 and 34 show the maximum bubble diameter averaged across 10 largest bubbles, for formulas with varying ratios of the foaming agents (i.e., sodium bicarbonate and citric acid) and varying levels of the surfactant (i.e., SLS). FIGS. 35 and 36 show the absolute maximum bubble diameter of the single largest bubble observed, for formulas with varying ratios of the foaming agents (i.e., sodium bicarbonate and citric acid) and varying levels of the surfactant (i.e., SLS).

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the numbers expressing quantities of ingredients, properties such as weight percentages, mortality rates, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A powder pest control composition, comprising:
from about 0.01 wt. % to about 5 wt. % of an essential oil;
from about 60 wt. % to about 99 wt. % of a foaming agent;
an anti-caking agent; and
a surfactant;
wherein all weight percentages are percent by weight of the total composition.

2. The powder pest control composition of claim 1, wherein the essential oil comprises mint oil, lemongrass oil, Geranium oil, cinnamon oil, cedarwood oil, rosemary oil, clove bud oil, or any combinations thereof.

3. The powder pest control composition of claim 1, wherein the essential oil comprises mint oil or lemongrass oil.

4. The powder pest control composition of claim 1, wherein the foaming agent comprises an alkali carbonate and an acid, and wherein the alkali carbonate and the acid have a weight ratio of about 1:1 to about 2:1.

5. The powder pest control composition of claim 4, wherein the alkali carbonate comprises sodium bicarbonate and the acid comprises citric acid.

6. The powder pest control composition of claim 1, comprising about 3 wt. % to about 10 wt. % of anti-caking agent.

7. The powder pest control composition of claim 1, wherein the anti-caking agent comprises silica.

8. The powder pest control composition of claim 1, comprising about 0.5 wt. % to about 5 wt. % of surfactant.

9. The powder pest control composition of claim 1, wherein the surfactant comprises sodium lauryl sulfate.

10. The powder pest control composition of claim 1, wherein the total amount of essential oil and the total amount of surfactant have a weight ratio of about 1:1 to about 1:8.

11. A powder pest control composition, comprising:
an essential oil comprising mint oil, lemongrass oil, Geranium oil, cinnamon oil, cedarwood oil, rosemary oil, clove bud oil, or any combinations thereof;
a foaming agent comprising an alkali carbonate and an acid;
an anti-caking agent; and
a surfactant.

12. The powder pest control composition of claim 11, comprising from about 0.01 wt. % to about 5 wt. % of essential oil by weight of the total composition, wherein the essential oil comprises mint oil or lemongrass oil.

13. The powder pest control composition of claim 11, comprising from about 60 wt. % to about 99 wt. % of foaming agent by weight of the total composition.

14. The powder pest control composition of claim 11, wherein the alkali carbonate and the acid have a weight ratio of about 1:1 to about 2:1, and wherein the alkali carbonate comprises sodium bicarbonate and the acid comprises citric acid.

15. The powder pest control composition of claim 11, comprising about 3 wt. % to about 10 wt. % anti-caking agent by weight of the total composition, wherein the anti-caking agent comprises silica.

16. The powder pest control composition of claim 11, comprising about 0.5 wt. % to about 5 wt. % of surfactant by weight of the total composition, wherein the surfactant comprises sodium lauryl sulfate.

17. The powder pest control composition of claim 11, wherein the total amount of essential oil and the total amount of surfactant have a weight ratio of about 1:1 to about 1:8.

18. A method of treating pests in a drain pipe system, comprising:
introducing to the drain pipe system a powder pest control composition comprising at least one essential oil, a foaming agent, an anti-caking agent, and a surfactant;
activating the pest control composition by adding an amount of water to the drain pipe system effective to cause the pest control composition to react and generate a foam before or after the introduction of the pest control composition; whereby the foam generated expands within the drain pipe system and comes in contact with the pests in the drain; and
allowing the foam to remain in contact with the pests in the drain for a sufficient time.

19. (canceled)

20. (canceled)

21. A powder pest control composition, comprising:
an essential oil;
a foaming agent;
an anti-caking agent; and
a surfactant;
wherein the composition generates a foam upon addition of a sufficient amount of water; and
wherein
the foam has a total volume of at least 1,000 mL³; or
the foam expands for a total distance or achieves a total height of at least 1 meter, in a pipe with a diameter of between about 1.0 and about 5.0 inches; or
the foam achieves a total cling time to a non-horizontal pipe wall of at least 40 seconds; or
the foam comprises bubbles with an average maximum diameter of less than 10 mm; or
any combination thereof.

22. (canceled)

23. (canceled)

24. (canceled)

25. The powder pest control composition of claim 21, comprising about 0.5 wt. % to about 5 wt. % of the surfactant and from about 60 wt. % to about 99 wt. % of the foaming agent:
wherein the foaming agent comprises an alkali carbonate and an acid, and wherein the alkali carbonate and the acid have a weight ratio of about 1:1 to about 2:1.

26. (canceled)

27. (canceled)

28. (canceled)

29. (canceled)
